(19) United States
(12) Patent Application Publication
(10) Pub. No.: US 2008/0179253 A1
(43) Pub. Date: Jul. 31, 2008

(54) Porous Particulate Material For Fluid Treatment, Cementitious Composition and Method of Manufacture Thereof

(76) Inventors: Malcolm William Clark, New South Wales (AU); Fiona Gaye Davies-McConchie, New South Wales (AU); David McConchie, New South Wales (AU); Leon Munro, Tasmania (AU); Daniel Faux, Queensland (AU)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/596,795

(22) PCT Filed: Dec. 24, 2004
(86) PCT No.: PCT/AU2004/001826

§ 371 Date: Oct. 22, 2007

(30) Foreign Application Priority Data
Dec. 24, 2003 (AU) 2003907205
Sep. 29, 2004 (AU) 2004905629

(51) Int. Cl. B01D 15/00; B01J 21/16

(52) U.S. Cl. 210/660; 502/80

(57) ABSTRACT

A porous particulate material for treating a fluid containing a contaminant is disclosed. The particulate material comprises a cementitious matrix or binder and treated bauxite refinery residue or red mud. At least a portion of the pores in the particulate material is open cell or interconnected pores. The invention also relates to the use of a reactive permeable barrier comprising porous material, for treating a contaminated fluid. Also disclosed is a method for producing porous particulate material for treating a contaminated fluid and a method for treating a contaminated fluid, in which the porous material is used. The invention furthermore relates to a cementitious composition comprising partially neutralised red mud and cement, wherein the partially neutralised red mud has been pre-treated by contacting it with water having a total hardness supplied by calcium, magnesium or a combination thereof, of at least 3.5 millimoles per litre calcium carbonate equivalent. The cementitious composition is useful as a building and construction material.

### TECHNICAL FIELD

This invention relates to the treatment of one or more contaminants in a fluid. More particularly, the invention relates to porous particulate material for the treatment of a fluid containing a contaminant and to a process for making such particulate material.

The present invention also relates to cementitious compositions. More particularly, the invention relates to cementitious compositions that can be produced and applied using conventional pouring, pumping, grouting and shotcreting methods, and that are useful for application as acid resistant cementitious compositions, sulfate resistant cementitious compositions, saline brine resistant cementitious compositions, fine-grained surface textured cementitious compositions, aerated or blown cementitious compositions, terracotta cementitious compositions, and the like. The invention also relates to a process for the manufacture of such compositions.

### BACKGROUND OF THE INVENTION

Acid mine drainage (AMD) is a well known problem wherever sulphidic mine tailings are stored; it affects most copper, lead, zinc, nickel and silver mining and smelting operations, most gold recovery operations other than those involving placer deposits, many coal mining and beneficiation operations and others. A potential environmental hazard exists wherever human activity involves exposing sulphide minerals to the atmosphere such that the sulphides can oxidise producing acid water that often has a high trace metal content. Some of these trace metals have high ecological toxicities, which are highly detrimental to the environment. Preventing the formation and escape of acidic metal-rich leachate from mineral recovery operations poses a management problem for modern mining operations and a major remediation problem for waste deposits associated with abandoned mining operations. The control of AMD is an expensive activity for both current and former mine sites. The release of acidic metal-rich waters from current and former mine sites is widely considered to be the greatest environmental hazard associated with mining and ore beneficiation operations.

Similarly, many industrial processes also produce acid metal-rich waste steams (e.g., tanneries, electro-plating works, fertiliser manufacturing and many others) that require treatment before they can be discharged or disposed of. Many industrial and waste management processes also produce gaseous emissions that contain odour producing compounds or components that can produce acid when they interact with water.

There accordingly exists a need for processes and compositions that can be used for the treatment of large volumes of acidic waters and trace metal-contaminated waters, such as those referred to above, at low cost.

Alumina (Al₂0₃) is produced industrially in the Bayer process. The Bayer process uses sodium hydroxide (NaOH) to selectively dissolve the aluminous minerals that are present in bauxite ore. This produces a sodium-aluminate solution from which pure Al(OH)₃ is precipitated. The residues that result from caustic soda digestion of the bauxite ore are commonly known as ‘red mud’. Bauxite refinery residues or red mud have a high ferric iron content and are highly caustic with pH values of about 13.5. In alumina production, large volumes of these highly caustic bauxite refinery residues are produced and can be difficult to dispose of safely and economically.

Geochemical studies of bauxite refinery residues have shown that they are dominated by particles with a very high surface area/volume ratio and a high particle charge to mass ratio. These studies have also shown that bauxite refinery residues that have had their pH reduced such that they retain their alkalinity but are not caustic, can neutralise acid and bind many trace is elements and other compounds by formation of new low solubility minerals, by coprecipitation with other minerals and by isomorphous substitution for elements in other minerals.

Despite the desirable acid neutralising and metal binding characteristics of red mud, it is difficult to handle, has a high moisture content that substantially increases transport costs, has a very low permeability, and forms a fine red dust when physically broken up when dry. These limitations are not a serious impediment when treating standing waters in remote areas, but they do adversely affect the ability to treat flowing acid waters, metal-rich waters and waters in areas near population centres, as well as gaseous emissions. They further impose major constraints on the use of red mud in permeable reactive barriers or passive water treatment columns or tanks where it is necessary to maintain moderate permeabilities. Clearly, in the form in which it is produced by bauxite refineries, red mud cannot be applied to treat flowing water bodies because the potential loss of fine red mud particles down stream is unacceptable. Furthermore, due to the small particle size of fine red mud particles, they are often not suitable for use in reactive barriers.

At their most basic level, concretes consist of sand, gravel (or aggregate) and cement that are combined with water to promote a tobermorite gel that binds the sand and gravel (or aggregate) as a solid mass, by converting oxides into aluminates and silicates. For ordinary Portland cement (OPC), the four principle components of cementation are tri-calcium silicate (C3S), di-calcium silicate (C2S), tri-calcium aluminate (C3A) and tetra-calcium alumino-ferrite (C4AF). High alumina cements are also used to provide superior resistance to saline waters and high temperatures, but these generally have lower strengths and are more expensive.

TABLE 1
Some common cementitious compositions

| Sand | Gravel | Cement | Other* | Purpose |
|---|---|---|---|---|
| 6 | 0 | 1 | 0-1 | Mortar |
| 4 | 3 | 1 | 0-1 | Fill Concrete |
| 3 | 4 | 1 | 0-1 | Coarse Fill Concrete |
| 5 | 2 | 1 | 0-1 | General Purpose Concrete |
| 2 | 3 | 1 | 0-1 | Structural Concrete |

*other components may include fly ash, silica fume, plasticizer and reinforcing.

Large quantities of red mud are produced annually by bauxite refineries in Australia and other countries, and because of the environmental problems that could potentially be caused by the caustic red mud, particularly where it has been dumped over a long period of time, economically sustainable and environmentally acceptable methods of disposal thereof are in great demand.

Various attempts have been made to utilize red mud in cementitious compositions. In this regard, Singh, M, reviewed the literature in Chapter I of his MTech dissertation entitled: Studies on the Preparation of Stabilized Blocks and Special Cements from Hindalco's Uncausticized Mud and Fly Ash, Department of Chemical Engineering & Technology, Institute of Technology, Banaras Hindu University, Varanasi, India (May 1995). However, none of the publications reviewed in this dissertation disclosed the cementitious compositions of the present invention or processes of making them.

Bricks containing red mud, cement and sand have been made in Jamaica. The bricks were found to have a compressive strength of about 4.7 MPa.

French patent publication No 2 760 003 discloses an iron-rich cement clinker containing red mud and limestone or other calcium oxide containing material. The clinker was fired in a kiln at a temperature of form 1175° C. to 1250° C. Washed and unwashed red mud was used. This document also discloses an hydraulic cement that was obtained from the aforementioned clinker. It furthermore discloses the production of hydraulic cements and mortars from a red mud based cement clinker mixed with lime-containing material and additional red mud. Apart from washing with water and heating to a temperature exceeding 1175° C., at which certain constituents of red mud will have decomposed, this document does not disclose any further processing of the red mud before it is incorporated in the cementitious compositions.

U.S. Pat. No. 5,456,553 describes the use of red mud combined with iron oxide powder and lime as a reinforcing agent for soil. It does not disclose the production of a cementitious composition nor of concrete.

U.S. Pat. No. 5,931,772 describes the production of compositions using dewatered, dried and sieved red mud combined with a waste material, followed by mixing with a pozzolanic material (cement, flyash or lime). This patent describes the treatment and encapsulation of a waste product as a relatively chemically inactive solid waste for disposal as landfill. The red mud used was not neutralized.

U.S. Pat. No. 3,989,513 describes the mixing of red mud with calcium oxide materials and reducing agents for the purpose of smelting iron ore at high temperatures. This patent does not disclose the use of red mud in cementitious compositions.

The Canadian Building Digest (http://irc.nrc-cnrc.qc.ca/cbd/cbd215e.html) suggests the use of vitrified red mud as a concrete aggregate. Vitrified red mud differs from red mud as vitrified red mud is chemically inactive. Vitrified red mud is used as a filling agent only. Vitrification removes the geochemical reactivity of red mud.

The International Research Development Centre (1992) http://web.idrc.ca/en/ev-2691-201-1-do_TOPIC.html suggested the mixing of red mud with other waste products, including flyash, to create construction bricks. Glanville, J. I. (1991). Bauxite waste bricks (Jamaica): Evaluation Report, June 1991. IDRC, Ottawa, evaluated bricks made of red mud and other waste products and indicated that the high sodium content caused salt leaching and salt efflorescence, which weakened the structures built using the red mud bricks. These publications did not consider the reduction in sodicity or the salt content of red mud used in brick construction.

Wagh, A. S., & Douse, V. E. (1991). Silicate bonded unsintered ceramic of Bayer process waste, Journal of Materials Research. Pittsburgh, Pa.: 6(5) 1095-1102 described the use of a silicate bonded ceramic made of Bayer process waste, as a ceramic material. This publication did not disclose the use of cement as a pozzolanic material in a composition together with red mud, or the use of red mud as a construction material, or the use of neutralised red mud with reduced sodicity.

### OBJECTS OF THE INVENTION

It is an object of the present invention to address or ameliorate at least one of the aforementioned disadvantages or needs.

### SUMMARY OF THE INVENTION

According to a first aspect of the invention, there is provided a porous particulate material for treating a fluid containing a contaminant, the particulate material comprising a cementitious matrix and bauxite refinery residue.

Advantageously, the volume percent of pores within the particulate material is in the range selected from the group consisting of 10% to 90%; 20% to 80%; 30% to 70%; 40% to 60%; or 45% to 55%. Suitably, at least a portion of the pores in the particulate material may be open cell or interconnected pores. Preferably, at least 10% of the pores are open cell or interconnected pores. More preferably, the proportion of pores that are open cell or interconnected pores within the particulate material are in the range selected from the group consisting of 10% to 100%; 20 to 100%; 30 to 100%; 40 to 100%; 50 to 100%; 60 to 100%; 70 to 100%; 80 to 100%; and 90 to 100%.

Advantageously, the pores of the particulate material have a distributed pore size. The pore size of the particulate material may be within the range of 0.1 to 2000 μm. The pores may consist of macro-pores having a pore size in the range of 100 to 2000 μm, mesopores having a pore size in the range of 10 to 100 μm and micro-pores having a pore size in the range of 0.1 to 10 μm. At least some of the macro-pores should be interconnected by meso-pores or micro-pores and at least some of the meso-pores are interconnected by micro-pores.

According to a second aspect of the invention, there is provided a porous particulate material for treating a fluid containing a contaminant, the particulate material comprising a coherent mass of particles, wherein the particles comprise a cementitious matrix and bauxite refinery residue.

Suitably, the particulate material may be present in the form selected from the group consisting of granules, pellets, briquettes, extrudites, gravel, cobbles, blocks, interlocking blocks or slabs.

According to a third aspect of the invention, there is provided a reactive permeable barrier for treating a fluid containing a contaminant comprising a permeable mass of the porous particulate materials according to the first or second aspect or both, wherein in use the permeable mass of the porous particulate materials are disposed within a flow path of the fluid containing the contaminant.

The reactive permeable barrier may be a sub-surface reactive permeable barrier. In other embodiments, the reactive permeable barrier may be located in a vessel such as a column or tank.

According to the fourth aspect of the invention, there is provided a composition for forming porous particulate material for treating a fluid containing a contaminant, the composition comprising bauxite refinery residue and a cementitious binder, wherein the cementitious binder is present in a sufficient quantity to form porous particulate material according to the first or second aspect or both.

Suitably an pore generating agent may be included in the composition to generate pores within the particulate material upon mixing the composition in an aqueous media. The pore generating agent may be selected from the group selected from, but not limited to, hydrogen peroxide, organic polymers and foaming agents.

According to a fifth aspect of the present invention, there is provided a method for producing porous particulate material for treating a fluid containing a contaminant, the particulate material comprising a coherent mass of particles, the method comprising:

(a) mixing bauxite refinery residue and cementitious binder in aqueous media to form a slurry;
(b) curing the slurry within a defined temperature range and for a defined period of time to form porous particulate materials having a cementitious matrix and bauxite refinery residue.

According to a sixth aspect of the present invention, there is provided a method for producing a porous particulate material for treating a fluid containing a contaminant, the particulate material comprising a coherent mass of particles, the method comprising:

(a) mixing bauxite refinery residue and cementitious binder in aqueous media to form a slurry;
(b) curing the slurry in a mould to form a coherent mass of porous particulate material having a cementitious matrix and bauxite refinery residue.

The mould may be shaped to form a coherent mass of porous particulate material in the form selected from the group consisting of granules, pellets, briquettes, extrudites, gravel, cobbles, blocks, interlocking blocks or slabs.

Suitably a pore generating agent may be added in the mixing step to generate pores within the particulate material. The pore generating agent may be selected from the group selected from, but not limited to, hydrogen peroxide, organic polymers, foaming agents, and gasses such as air.

Suitably, a phosphatising agent may be added to assist in stabilisation of the pore structures during curing. The phosphatising agent may be phosphoric acid.

The slurry may be allowed to cure for a period of from 1 day to 60 days, preferably from 1 day to 50 days, more preferably from 1 to 30 days.

According to a seventh aspect of the present invention, there is provided a method for treating a fluid containing a contaminant, the method comprising:
providing a permeable mass of porous particulate materials according to the first or second aspect or both; and
passing the fluid containing the contaminant through the permeable mass of porous particulate materials.

The fluid may be a contaminated water or a contaminated gaseous fluid. The contaminant in the fluid may be selected from the group consisting of, but not limited to, acids; metal ions such as lead, aluminium, beryllium, cadmium, chromium, cobalt copper, iron, nickel, manganese, mercury, silver, zinc; metalloids such as antimony or arsenic; and anions such as borate, carbonate, cyanide, metal oxyanion complexes, oxalate, phosphate, sulfate, halides, and; gasses such as carbon dioxide, nitric oxide, nitrous oxide, sulphur dioxide, sulphur trioxide; and one or more combinations thereof.

The composition or the slurry may comprise from 1% to 99% w/w of bauxite refinery residue and from 1% to 99% of a cementitious binder. A preferred composition includes from 50% to 95% by dry weight of bauxite refinery residue and from 5% to 50% by weight of cementitious binder. A more preferred composition includes from 70% to 90% by weight of bauxite refinery residue and from 10% to 30% by weight of cementitious binder, and a most preferred composition comprises from 80% to 85% by dry weight of the bauxite refinery residues and from 15% to 20% by weight of cementitious binder. Advantageously, additional additives may be added to the bauxite refinery residue, the additional additives selected from the group consisting of sand and ground caustic steel slag residue, alkali metal hydroxides such as sodium hydroxide, alkali metal carbonates such as sodium carbonate, alkaline earth metal hydroxides such as calcium hydroxide, alkaline earth metal carbonates such as calcium carbonate, alkaline earth metal oxides such as magnesium oxide, calcium hypochlorite, sodium alum, ferrous sulfate, ferric sulphate, ferric chloride, aluminium sulfate, gypsum, phosphates such as ammonium phosphate, phosphoric acid, hydrotalcite, zeolites, olivines and pyroxenes (including those present in basic and ultra basic igneous rocks) barium chloride, silicic acid and salts thereof, meta silicic acid and salts thereof, jarosite or other alunite group minerals and magadiite, and one or more combinations thereof. The additional additives may be added to the slurry provide a composition with an enhanced acid neutralising capacity or an enhanced ability to remove a specific contaminant in the fluid.

Suitably, the bauxite refinery residues have a pH less than about 10.5. Preferably, the bauxite refinery residues have a pH in the range between about 8 and about 10.

A cementitious binder capable of forming a tobermorite gel is preferred. A preferred cementitious binder is a cement selected from the group consisting of normal portland cement, high early strength portland cement, low heat portland cement, sulphate resisting portland cement, and high alumina cements, or any other commercially available cementing agent that relies on the development of tobermorite gels.

In the context of this specification, the term “comprising” means “including principally, but not necessarily solely”. Furthermore, variations of the word “comprising”, such as “comprise” and “comprises”, have correspondingly varied meanings.

The term “red mud” hereafter may include “treated red mud”, “partially treated red mud”, “untreated red mud” and bauxite refinery residue.

The term “treated red mud” hereafter means red mud that has a pH less than 10.5.

The term “partially treated red mud” hereafter means red mud that has a pH in the range of 10.5 to less than 13.5. The term “untreated red mud” means red mud that has a pH of 13.5 or more.

### Partially Treated Red Mud for Porous Pellet Production

The treatment of the red mud may comprise a treatment with calcium and/or magnesium ions so as yield a substance that has a reaction pH of less than 10.5 when mixed with water in a weight ratio of red mud to water of 1:5. Alternatively, the treatment of the red mud may comprise neutralisation thereof by the addition of acid. As another alternative, the treatment of the red mud may comprise contact with carbon dioxide; or the addition of a mineral such as gypsum.

The treated red mud may be red mud that has been activated by acid treatment neutralisation and calcination or red mud that has been chemically and/or physically altered in any other way such as by washing with water or size separation.

The red mud may be at least partially reacted with calcium and/or magnesium ions so as to have a reaction pH, when mixed with 5 times its weight of water, of less than 10.5 to become treated red mud. More preferably the reaction pH, when mixed with 5 times its weight of water, is less than a value selected from the group consisting of about 10, about 9.5, about 9, about 8.5 and about 8. The reaction pH of treated red mud, when mixed with 5 times its weight of water, may be about 8-10.5, alternatively about 8.5-10, alternatively about 8-8.5, alternatively about 8-9, alternatively about 8.5-9.5, alternatively about 9-10, alternatively about 9.5-10, alternatively about 9-9.5, and may be about 10.5, 10, 9.5, 9, 8.5 or 8.

One method by which treated red mud, as defined herein, may be prepared is by reacting untreated or partially treated red mud with calcium and/or magnesium ions as described in International Patent Application No. PCT/AU03/00865 and International Patent Application No. PCT/AU01/01383, the contents of which are incorporated herein in their entirety. Another way in which treated red mud may be prepared is by reaction of untreated or partially treated red mud with sufficient quantity of seawater to decrease the reaction pH of the red mud to less than 10.5. For example, it has been found that if an untreated red mud has a pH of about 13.5 and an alkalinity in the liquid phase of about 20,000 mg/L, the addition of about 5 volumes of world average seawater will reduce the pH to between 9.0 and 9.5 and the alkalinity to about 300 mg/L.

As taught in International Patent Application No. PCT/AU03/00865 and International Patent Application No. PCT/AU01/01383, a process for reacting untreated or partially treated red mud with calcium and/or magnesium ions may comprise mixing untreated or partially treated red mud with an aqueous treating solution containing a base amount and a treating amount of calcium ions and a base amount and a treating amount of magnesium ions, for a time sufficient to bring the reaction pH of the red mud, when one part by weight is mixed with 5 parts by weight of distilled or deionised water, to less than 10.5. The base amounts of calcium and magnesium ions are 8 millimoles and 12 millimoles, respectively, per litre of the total volume of the treating solution and the red mud; the treating amount of calcium ions is at least 25 millimoles per mole of total alkalinity of the red mud expressed as calcium carbonate equivalent alkalinity and the treating amount of magnesium ions is at least 400 millimoles per mole of total alkalinity of the red mud expressed as calcium carbonate equivalent alkalinity. In addition to the possible use of seawater, as taught in International Patent Application No. PCT/AU03/00865 and International Patent Application No. PCT/AU01/01383, examples of sources of calcium and magnesium include hard groundwater brines, natural saline brines (e.g. evaporatively concentrated seawater, bittern brines from salt mines or salt lake brines), saline wastewaters (e.g. from desalination plants), and solutions made by dissolving calcium chloride and magnesium chloride. However, sources of calcium and/or magnesium ions are not limited to these examples.

A further method by which treated red mud may be prepared comprises the steps of:

(a) contacting the untreated or partially treated red mud with a water soluble salt of an alkaline earth metal, typically calcium or magnesium or a mixture of the two, so as to reduce at least one of the pH and alkalinity of the red mud; and

(b) contacting the untreated or partially treated red mud with an acid so as to reduce the pH of the red mud to less than 10.5.

In step (b), the pH of the red mud may be reduced to about 8.5-10, alternatively to about 8.5-9.5, alternatively to about 9-10, alternatively to about 9.5-10, preferably from about 9-9.5, and may be reduced to a value selected from the group consisting of about 10.5, about 10, about 9.5, about 9, about 8.5 and about 8.

In step (a) of this process, the total alkalinity of the liquid phase, expressed as calcium carbonate alkalinity, of the red mud may be reduced to about 200 mg/L-1000 mg/L, alternatively to about 200 mg/L-900 mg/L, alternatively to about 200 mg/L-800 mg/L, alternatively to about 200 mg/L-700 mg/L, alternatively to about 200 mg/L-600 mg/L, alternatively to about 200 mg/L-500 mg/L, alternatively to about 200 mg/L-400 mg/L, alternatively to about 200 mg/L-300 mg/L, alternatively to about 300 mg/L-1000 mg/L, alternatively to about 400 mg/L-1000 mg/L, alternatively to about 500 mg/L-1000 mg/L, alternatively to about 600 mg/L-1000 mg/L, alternatively to about 700 mg/L-1000 mg/L, alternatively to about 800 mg/L-1000 mg/L, alternatively to about 900 mg/L-1000 mg/L, preferably less than 300 mg/L, and may be reduced to less than a value selected from the group consisting of about 1000 mg/L, about 900 mg/L about 800 mg/L about 700 mg/L about 600 mg/L, about 500 mg/L, about 400 mg/L, about 300 mg/L and about 200 mg/L or may be reduced to a value selected from the group consisting of about 1000, about 950, about 900, about 850, about 800, about 750, about 700, about 650, about 600, about 550, about 500, about 450, about 400, about 350, about 300, about 250 and about 200 mg/L.

The pH is typically reduced to less than about 9.5, preferably to less than about 9.0, and may be reduced to a value selected from the group consisting of about 9.5, about 9.25, about 9.0, about 8.75, about 8.5, about 8.25 and about 8 and the total alkalinity of the liquid phase, expressed as calcium carbonate equivalent alkalinity, is preferably reduced to less than a value selected from the group consisting of about 200 mg/L, about 150 mg/L and about 100 mg/L, and may be reduced to a value selected from the group consisting of about 200, about 175, about 150, about 125, about 100, about 75 and about 50 mg/L.

Treated red mud, as defined herein for purposes of porous pellet manufacture, is a dry red solid that consists of a complex mixture of minerals that usually includes: abundant hematite, boehmite, gibbsite, sodalite, quartz and cancrinite, minor aragonite, brucite, calcite, diaspore, ferrihydrite, gypsum, hydrocalumite, hydrotalcite, p-aluminohydrocalcite and portlandite, and a few low solubility trace minerals. It has a high acid neutralising capacity (2.5-7.5 moles of acid per kg of treated red mud) and a very high trace metal trapping capacity (greater than 1,000 milliequivalents of metal per kg of treated red mud); it also has a high capacity to trap and bind phosphate and some other chemical species. Treated red mud can be produced in various forms to suit individual applications (e.g. slurries, powders, pellets, etc.) but all have a near-neutral soil reaction pH (less than 10.5 and more typically between 8.2 and 8.6) despite their high acid neutralising capacity. The soil reaction pH of treated red mud is sufficiently close to neutral and its TCLP (Toxicity Characteristic Leaching Procedure) values are sufficiently low that it can be transported and used without the need to obtain special permits.

It will be appreciated form the foregoing, however, that the red mud for use in the compositions and methods of the present invention is not limited to treated red mud, as herein defined, and may also be red mud that has been at least “partially treated” (i.e. has a pH between 10.5 and 13.5) by treatment with acid; red mud that has been at least partially treated by treatment with carbon dioxide; or red mud that has been at least partially treated by addition of one or more minerals containing calcium and/or magnesium (such as gypsum). Red mud may conveniently be at least partially treated by treatment with carbon dioxide, by bubbling carbon dioxide into an aqueous suspension of red mud, or by injecting carbon dioxide into such a suspension under pressure, until the reaction pH of the red mud is decreased to less than a value selected from the group consisting of between 10.5 and 13.

The typical mineralogy and chemical composition of treated red mud is summarised in Table 2 below.

TABLE 2
Typical treated red mud composition

| | % Unwashed | (%) Washed |
|---|---|---|
| | Mean | Mean |
| Iron oxides¹ & oxyhydroxides | 31.6 | 33.2 |
| Hydrated alumina² | 17.9 | 18.1 |
| Sodalite | 17.3 | 17.8 |
| Quartz | 6.8 | 7.0 |
| Cancrinite | 6.5 | 6.5 |
| Titanium oxides³ | 4.9 | 5.0 |
| Ca(Al) hydroxides & hydroxycarbonates⁴ | 4.5 | 4.6 |
| Mg(Al) hydroxides & hydroxycarbonates⁵ | 3.8 | 3.9 |
| Calcium carbonates⁶ | 2.3 | 2.2 |
| Halite | 2.7 | 0.03 |
| Others⁷ | 1.7 | 1.7 |

¹Iron oxides & oxyhydroxides include hematite & ferrihydrite.
²Hydrated alumina includes: boehmite & gibbsite (mainly boehmite).
³Titanium oxides include: anatase & rutile
⁴Ca(Al) hydroxides & hydroxycarbonates include: hydrocalumite & p-aluminohydrocalcite.
⁵Mg(Al) hydroxides & hydroxycarbonates include: brucite & hydrotalcite
⁶Calcium carbonates include: calcite & aragonite
⁷“Others” include: diaspore, lepidocrocite, portlandite, chromite, monazite, zircon, fluorite, euxinite, gypsum, anhydrite, bassanite, whewellite.

The texture and mineralogy of treated red mud give it a very high trace element trapping and binding capacity (>1000 meq/kg, at pH values>6.5) and the ability to strip trace elements from water in contact with it. The metal binding property of treated red mud becomes stronger as it ages. In addition to the high metal binding capacities, treated red mud has an acid neutralising capacity that is greater than 3.5 moles of acid per kg of dry treated red mud and is usually greater than 4.5 moles of acid per kg of dry treated red mud. These properties make treated red mud suitable for a wide range of water treatment and other similar applications.

The mineral constituents of treated red mud are non-toxic to humans and animals either individually or collectively. Many of the minerals present in treated red mud are used in pharmaceutical products for human consumption.

The treated red mud or partially treated red mud is preferably finely ground.

A particular benefit of using treated red mud in the composition and process of the invention is that the soluble salt concentrations, especially sodium concentrations, are substantially lower than those in untreated red mud. This feature of treated red mud is particularly important where the salinity of treated must be low such as where the water is to be discharged to the environment or where it is to be used for irrigation purposes or as drinking water for mammals.

### Cementitious Binder

The cementitious substance may be a tobermorite gel. Most typically tobermorite gel is produced in the setting of industrial cements and includes, but need not be limited to (normal portland cement, high early strength portland cement, low heat portland cement, sulphate resisting portland cement, and high alumina cements, or any other commercially available cementing agent that relies on the development of tobermorite gels) and is hereinafter referred to as “cement”. Within a tobermorite gel, four main constituents are present, these are: tricalcium silicate (C₃S), dicalcium silicate (C₂S) tricalcium aluminate (C₃A) and tetracalcium alumino-ferrate (C₄AF).

The incorporation of organic additives during pellet formation can provide additional binding strength by producing a fibrous mat, while the xylem and phloem of the tissue can provide additional interconnecting pathways for fluid flow. In addition, organic matter provides a suitable bacteria growth medium, so that formed pellets may be used in anaerobic treatments that will allow biogeochemical reactions (e.g. sulphate reduction, and denitrification) to progress efficiently. Furthermore, organic matter within the pellets can provide additional nutrient and carbon sources for plant growth, should pellets be used in soil remediation programs or potting mix extenders. Organic matter that may be incorporated into pellets may include, but should not be limited to, sewage biosolids, sugarcane crushing residues, straw chaff, mulches, and hemp fibre, etc. The preferred range of added organic matter would be in the range of 0% to 15% by weight of the dry mixture, the more preferred range of 0.4% to 10% by weight of the dry mixture, the even more preferred range of 0.6% to 8% by weight of the dry mixture and a most preferred range of 0.8% to 5.0% by weight of the dry mixture.

### Mineral Additives

The operational benefits of the treated red mud can frequently be enhanced by the addition of mineral additives as taught in PCT/AU01/01383. Possible additives include one or more substances selected from the group consisting of alkali metal hydroxides (e.g. sodium hydroxide), alkali metal carbonates (e.g. sodium carbonate), alkaline earth metal hydroxides (e.g. calcium hydroxide), alkaline earth metal carbonates (e.g. calcium carbonate), alkaline earth metal oxides (e.g. magnesium oxide), calcium hypochlorite, sodium alum, ferrous sulfate, ferric sulphate, ferric chloride, aluminium sulfate, gypsum, phosphates (e.g. ammonium phosphate), phosphoric acid, hydrotalcite, zeolites, olivines and pyroxenes (including those present in basic and ultra basic igneous rocks), barium chloride, silicic acid and salts thereof, meta silicic acid and salts thereof, jarosite or other alunite group minerals and magadiite. One or more of these substances can be added to the mixture to be pelletised to enhance particular properties of the pellets. The preferred range of addition rates for any one mineral additive would be in the range of 0% to 30% by weight of the dry mixture, the more preferred range of 1% to 25% by weight of the dry mixture, the even more preferred range of 2% to 20% by weight of the dry mixture and a most preferred range of 5% to 15% by weight of the dry mixture. It should be understood that the addition of mineral additives will reduce the amount of red mud used.

### Slurry Water

If added in a suitable proportion, and mixed with a dry cementitious substance, water causes it to form a tobermorite gel. This is useful for pellet formation. However, if too little water is added, the resulting tobermorite gel sets into a solid substance that has an undesirably high level of macro-porosity and is of low strength, whilst, if too much water is added, the resulting tobermorite gel sets into a solid substance that has a low pore size distribution, lowered permeability and poor drying characteristics.

It is preferable to have the mixture slightly too wet than to have the mixture slightly too dry. Water should be added to the dry ingredients and blended till a smooth paste develops. The preferred range of water to be added depends on the treated red mud blend used, the proportion of acid neutralising hydroxide and oxide minerals present in the blend, and the initial water content of the treated red mud.

When treated red mud and portland cement is used as the binder, the preferred range for water addition is from 15% to 55% water to dry ingredients by weight, with a more preferred range of 25% to 45% water to dry ingredients by weight, with an even more preferred range of 30% to 40% water to dry ingredients by weight, and a most preferred range of 33% to 37% water to dry ingredients, by weight. However, the optimum amount of water will also depend on the moisture content of the red mud used (this may vary between batches) and consequently, the exact amount of water to be added will be determined by operator experience.

### Silica Providers

Other components may be included in the mix to provide additional silica sources for tobermorite gel formation and may include, but not be limited to silica sand, diatomite, fly ash, bottom ash, and crushed silicate rock, which may be added either alone or as combinations. The preferred range these added silica sources would be in the range of 0% to 30% by dry weight, the more preferred range of 3% to 20% by dry weight, and a most preferred range of 5% to 12% by dry weight.

### Plasticisers and Polymerisers

Plasticisers and/or polymerisers may also be added to the composition to facilitate pellet formation, to provide greater workability of the wetted mixture, to inhibit initial setting times, to provide additional binding strength to the cured product, and/or to provide a wettable surface for water to penetrate along pores into cured pellets, so as to prevent pellet slaking.

Plasticisers and polymerisers include, but should not be limited to cellulosic substances, such as methyl-hydroxyethyl-cellulose (MHEC) and hydroxypropyl-methyl-cellulose (HPMC) and polymerising agents such as dibutyl phthalate (DBP).

Highly substituted organic plasticisers and polymerisers are preferred for the addition to the pellet mixtures using treated red mud blends (e.g. HPMC), whereas in low ionic strength systems (e.g. freshwater rinsed treated red mud) less highly substituted plasticisers/polymerisers may be used (e.g. MHEC); salting out (excessive salt loading) of the plasticiser reduces plasticiser performance. The preferred plasticiser addition rate is from about 0.01% to about 8% by weight of the dry mixture, a preferred range being about 0.4% to about 5% by weight of the dry mixture, whilst an even more preferred range is about 0.6% to about 3% by weight of the dry mixture. A most preferred range is from about 0.8% to about 2.0% by weight of the dry mixture.

### Air Entraining Agents

The entrainment of air provides the porosity and permeability within pellets. Air may be entrained in one or both of two methods. Firstly, physical mixing of the slurry entrains small gas bubbles and secondly, air entraining agents either release gases under the chemical conditions of the slurry, or aid in the incorporation of air during slurry mixing. Air entraining agents may include hydrogen peroxide, organic polymers and commercially available organic foaming agents.

Hydrogen peroxide becomes unstable under the chemical conditions of the slurry and breaks down to evolve oxygen that expands to provide porosity. The upward migration of gas bubbles provides pellet permeability (the interconnection of porosity).

Hydrogen peroxide as an air entraining agent may be used in varying strengths, preferably in the range of 0.1% to 75% weight to volume hydrogen peroxide, more preferably between 1% to 30% weight to volume hydrogen peroxide, and most preferably between 3% to 10% weight to volume hydrogen peroxide. For a 3% weight to volume hydrogen peroxide, addition rates are preferably between 1 mL to 25 mL per kg of dry mixture, more preferably between 2 mL to 20 mL per kg of dry mixture, and even more preferably between 5 mL to 15 mL per kg of dry mixture, and most preferably between 8 mL to 10 mL per kg of dry mixture. Higher addition rates or higher concentrations of the air entraining agent provide greater porosity and permeability, but lower physical strength.

### Phosphatising Agents

The development of apatite like minerals within pellets and phosphate cross linking between mineral crystals may provide additional strength benefits, especially wet strength, which in combination with the air entraining agents aids micro-porosity development and stability. Phosphate may also act to trap and bind heavy metals. Phosphatising agents may be added to the pellet mixture and may include phosphoric acid, tri-sodium phosphate, di-sodium hydrogen-phosphate, sodium di-hydrogen phosphate, tri-potassium phosphate, di-potassium hydrogen-phosphate, potassium di-hydrogen phosphate.

The phosphatising agent may be phosphoric acid. The phosphoric acid may have a strength between about 0.01M and about 18M, preferably between about 0.1M and about 5M, more preferably between about 0.5M and about 3M, and even more preferably between about 1M and about 2M. At a phosphoric acid strength of 1.5M, the preferred addition rate may be 0.2 mL to 4 mL per kg of dry ingredients, preferably about 1 mL to about 3.5 mL per kg of dry ingredients, more preferably about 1.5 mL to about 2.5 mL per kg of dry ingredients, even more preferably about 2 mL to about 2.5 mL per kg of dry ingredients.

### Mixing

The dry materials may be sieved, preferably to <2 mm, more preferably to <1 mm, even more preferably <500 μm and most preferably <250 μm, and fully mixed to reduce material clumping, before the introduction of water or any other wet material such as an aqueous solution comprising the phosphatising agent and/or the air entraining agent.

The wet materials are preferably mixed together before addition to dry materials, but they may be added individually. If the wet ingredients are to be mixed with the dry ingredients individually then the preferred mixing order is to add water to the dry materials before the phosphatising agent or the air entraining agent is added.

Over mixing of the slurry (i.e., going from a slightly wet to slightly dry slurry) to ensure a complete entrainment of air during the mixing process is preferred. Mixing should preferably proceed until air entrainment is complete because air entrainment is substantially reduced once mixing is stopped.

Mixing can be achieved by various means, including commercially available shear-force mixers, and concrete mixers that turn over material. With mixing, the slurry material is preferably folded in on itself for at least 5 minutes, preferably at least for about 10 minutes at a rate of at least 10 times per minute, more preferably at about 20 times per minute, and even more preferably at about 30 times per minute (expressed as standard revolutions per minute for commercially available concrete mixers). Shear-force mixers (e.g. bread mixers) typically operate at higher mixing rates than standard concrete mixers, and depending on the machine specifications, mixing times may be adjusted accordingly.

### Pellet Moulding and Drying

The strength of a tobermorite gel continues to increase with time, for a period lasting several months, and even years. After about 28 days, further increases in strength occur increasingly slowly. Initial setting of cement is achieved by the development of the C₃A and C₄AF forms of tobermorite, over a period of 0-10 days, the C₃S and C₂S tobermorite gel forms over the period of 0-400 days.

### Slab Casting

The composition according to the invention may be cast in slabs. Slab pouring may require a mixer of sufficient volume (e.g. batching works off road works) with accurate scales, and an IBC mixer for mixing of plasticiser etc. Screening of all products may be necessary so a vibrating screen may be used above the mixer entry point for the cement, lime, magnesium oxide.

Treated red mud slurry may be pumped through a wet screen prior to addition to the mixer. Slab making may require a back-hoe for slab transportation and a crane where lifting hooks are to be moulded into the slab. Slabs may be stacked for storage, and may be allowed to dry in a shed before crushing, and then transported in bulk or in bags etc. Slabs may be transported whole and may be crushed on site. Slabs may be stored in open weather.

### Crushing

Once cured, the slabs or coarse pellet blocks may be crushed or mechanically chipped or cut/sheared and graded to provide pellets of any desired size. Pellets are preferably crushed to a size of less than about 1/10^{th} of the internal diameter of the column that they are to be packed in, more preferably to a size of less than about 1/20^{th} of the internal diameter of the column, even more preferably to a size of less than about 1/40^{th} of the internal diameter of the column, and most preferably to a size of less than about 1/50^{th} of the internal diameter of the column.

Typically, the crushed pellets will have a size distribution in a preferred range of about 0.05 mm to 100 mm, with a more preferable size distribution range of about 0.1 mm to about 10 mm, a more preferred size distribution range of about 0.2 mm to about 5 mm, and a most preferred size distribution range of about 0.5 mm to about 2.5 mm. However, pellets with very different size ranges may be selected for particular applications as required. For example, large particles (cobble size) may be required for use in stream bed applications, whereas pellets with sizes between 0.5 mm and 2 mm may be the most suitable for small water treatment columns.

### Formation of Particles

The compositions of the invention may be provided in the form of a particulate blend or they may be provided as granules, pellets, tablets, bricks, chunks or blocks composed of the mixed components depending on the crushing or cutting procedures used. Preferably, the compositions of the invention are provided in the form of pellets made from an intimate mixture of the components of the composition. Any coarse particles are preferably crushed, cut/sheared or ground. After said crushing, cuffing or grinding, particles are sieved or screened to provide the desired size range for each application. Sizes will typically be in the range 0.05 mm to 10 cm. However, as a result of crushing, cutting or grinding, some particles may have a diameter of less than 0.05 mm. Material less than 0.05 mm will usually need to be removed from the particles to maintain permeability during use but need not be discarded.

The fine material removed following crushing, grinding or cutting can also be pelletised by pressing the homogeneous mixture into pellets using a hydraulic press, or by using compression rollers, or a prilling machine, or any other similar means determined to be convenient or efficient. Pressed pellets that are strong and stable enough to survive transport and moderately rough handling can be readily formed using an applied compression of about 50 MPa or more. However, an applied compression of greater than about 150 MPa is preferred and an applied compression of greater than about 250 MPa is still more preferred. Applied compression of about 50, 100, 150, 200, 250, 300, 350 or 400 MPa, or between about 50 and 500 MPa, or between about 100 and 450 MPa, or between about 150 and 400 MPa or between about 200 and 350 MPa may be used. Strong and stable pellets may also be produced from a damp slurry that has been prepared by adding water to the homogeneous mixture. At a suitable moisture content pellets can be prepared by rolling the mixture with little or no compression; commercially available pellet binders (used in the chemical, pharmaceutical, or similar industries; for example methylcellulose or other cellulose derivatives) can be added to the mixture to provide additional physical strength if desired.

The composition according to the invention may be used in several permeable water treatment systems, including water quality management barriers, subsurface reactive barriers, and filtration columns.

### Water Quality Management Barriers

The composition according to the invention may be used to make permeable barriers that may be placed in creeks or drains to neutralise acid and remove metals, metalloids and some other potential contaminants (e.g. cyanide and phosphate) from water in the creeks or drains without stopping water flow. As the water flows through the water quality management barrier in the water course, its quality is substantially improved.

The composition according to the invention may be packed in porous bags or similar containers that may be placed in the water course as required. A preferred container is in the form of a geotextile bag with a fine pore size (<5 microns), but other materials could also be used to construct the containers.

The barriers may be constructed in any size or shape, including the following:

A) Bags shaped like pillows that hold between 15 kg to 30 kg of pellets; these are like sand bags that are used in flood management. The bags may be larger or smaller as required, but this is a convenient size for installation by hand where necessary. These bags may be suitable for temporary placement in small drains or water courses.
B) Bags shaped like sausages and designed to hold 15 kg to 50 kg or more of pellets made of the composition according to the invention. There is no limit on the size but larger sausages may be more difficult to place in position and may require the use of lifting machinery. These bags may be suitable for use in larger water courses or for making an emergency barrier to surround a spill or unintended discharge of contaminated water.
C) Elongate bags may be provided with a trapezium shaped cross-section and a length designed to extend from one side of a drain or water course to the other and are pinned to the bottom of the water course. Bags with this design may be suitable for more permanent use in drains or water courses where the water flow volume is highly variable. These bags may be suitable to treat the water when flow rates are low and contaminant concentrations are high. When flow rates are low and contaminants are highly diluted, water treatment is less important and under these circumstances the water will simply flow over the top of the water quality management barrier without reducing the acid neutralising or contaminant trapping capacity of the composition in the bags. Thus water may be treated when necessary and not when discharge conditions make treatment unnecessary.

Bags containing the composition according to the invention may be kept at sites close to where they might be needed in the event of a spill of contaminated water or where some form of emergency response to the release of acidic metal-contaminated water may become necessary. In the latter sense, the bags may be used like the barriers stored for rapid response to an oil spill. The hydraulic conductivity of the water quality management barriers is important. The ingredients of the composition according to invention and the process steps for processing the ingredients may be selected such as to meet the requirements of an individual application.

Because the water treating capacity of the composition according to the invention is limited, where the composition is used in long term applications, the performance of the composition needs to be monitored. Where the acid or metal removal capacity of the composition becomes depleted it will need to be replaced.

Monitoring can involve the checking of downstream water quality or sub-sampling the contents of the bags and testing the residual acid neutralising and metal binding capacity of the composition in the bag. Depending on the type of contaminants being trapped, once the water treating capacity of the composition is exhausted, the composition may often be suitable for reuse in agriculture as a soil conditioner or improver, thereby reducing the cost of replacing the composition in the bags.

### Sub-Surface Permeable Reactive Barriers

The composition according to the invention may be used to provide permeable sub-surface reactive barriers that may be placed in ground to neutralise acid and remove metals, metalloids and some other potential contaminants (e.g. cyanide and phosphate) from sub-surface waters, without impeding water flow. As the sub-surface water flows through the permeable sub-surface reactive barrier, the quality of the sub-surface water is improved.

Sub-surface reactive barriers or treatment walls may involve the construction of permanent, semi-permanent, or replaceable sections of walls or barriers, each comprising containers holding pellets of the composition according to the invention. The walls or barriers may be provided across the flow path of a ground water borne contaminant plume. Where a sub-surface reactive barrier comprising the composition according to the invention is to be replaceable, then a geotextile lining of the treatment zone may be provided to confine pellets to the treatment zone to assist in their removal. The pellets of the composition may be contained within a single geotextile liner that occupies the whole of the treatment zone. The barrier or wall may alternatively be or comprise geotextile bags as described previously. The bags may be stacked within the treatment zone to form a sub-surface reactive barrier.

Contaminated ground water may move passively through the sub-surface reactive barrier, because of a hydraulic gradient, and the contaminants in the water may be removed by physical, chemical and/or biological processes. Depending on the contaminant in the ground water to be treated, reactions may occur by precipitation, sorption, oxidation or reduction, fixation or degradation.

Sub-surface reactive barriers have several advantages to the conventional pump-and-treat methods for ground water remediation because contaminant treatment is occurring in-situ, without the need to bring the water to the surface. In addition, the treatment according to the invention does not require a continuous input of energy to run the pumps, because the natural hydraulic gradient is used to carry the contaminants trough the reaction zone. Also, only periodic replacement or rejuvenation of the sub-surface reactive barrier is required should it become exhausted, or clogged during the barrier life time.

Barriers are conveniently designed to have a capacity to treat large volumes of contaminated groundwater. In some situations, because of costs, barriers may be installed that only treat a portion of the total problem. When the treatment capacity of the barrier has become depleted, it may be simpler and cheaper to rather emplace a new barrier slightly up flow of the failing barrier than to excise and replace it. In that way the costs of a treatment program may be spread out over a number of years.

To emplace a sub-surface barrier, a simple trench may be excavated across the groundwater plume and backfilled with the reactive material. The trench may be dug using specialist trenching equipment. The dimensions of the trench may be based on the permeability of the reaction material, the permeability of the surrounding geological materials, the required residence time for contaminant removal reactions to occur within the barrier, the concentration of contaminant in the influent water, the width and depth of the contaminated ground water plume, and the design life of the sub-surface reactive barrier. In addition, other earth works may be provided to direct the ground water flow to the reactive barrier (e.g. a funnel and gate system). The permeability of the barrier according to the invention may be controlled by increasing or decreasing the particle size of the composition.

### Filtration/Reaction Columns or Tanks

The composition according to the invention may be used to pack a permeable column or tank to neutralise acid and remove metals or metalloids and some other potential contaminants (e.g. cyanide and phosphate) in water, without severely impeding water flow.

The water may be an industrial effluent, a contaminated drinking water or an acid mine drainage water.

The water may be passed through the column or tank under gravity (either as a direct feed or by siphon), be pumped through the column, or be sucked trough the column or tank under vacuum. As the water flows through the permeable column or tank, its quality may be substantially improved.

A filtration/reaction column or tank in accordance with the invention may be a column or tank comprising the composition according to the invention. The filtration/reaction column or tank may be a suitable tube packed with the composition according to the invention. The water may be passed from one end to the other to effect the removal of a particular contaminant. Contaminants may be removed because of precipitation, sorption, oxidation or reduction, fixation or degradation reactions, or may be removed because they are attached to suspended particles within the water, which are removed by the pellets by physical separation because they cannot pass though the interconnecting pore spaces. Columns or tanks may be constructed from almost any material, including bamboo, pvc pipe, polyethene drums, stainless steel pipe, and polycarbonate tubing, or any other suitable material. At least one end should be capped to hold the filtration/reaction media within the container. The advantages of using filtration/reaction column or tank, are that the filtration/reaction media are readily replaced when overloading occurs, it is easy to monitor flow rates through the system to determine if physical clogging is occurring, the flow rates and retention times are readily adjusted, effluent water quality is easy to monitor, columns or tanks can be constructed to any desired height and diameter, and they may be engineered to allow back-flushing as required.

Because the filtration/reaction media within the filtration/reaction column or tank is in contact with a ridged tube edge, some preferential flow paths may develop between these boundaries. In addition very fine grained media are less desirable in filtration/reaction columns or tanks, because there is a propensity for fine grained media to clog. To over come these problems the grainsize of the pellets in the column or tank is limited by the internal diameter of the column or tank, such that the pellets should have a grain size of less than 1/10^{th} of the internal diameter of the column or tank. In addition, treatment in the column or tank is most effective when the pellet grainsize is less than 1/50^{th} of the internal diameter of the column. However, to prevent substantial clogging of the filtration/reaction media, greater than 80% of the pellets should be coarser than 100 μm and preferably greater than 90% of the pellets should be coarser than 100 μm and more preferably greater than 95% of the pellets should be coarser than 100 μm and most preferably greater than 98% of the pellets should be coarser than 100 μm.

To prevent clogging of the filtration/reaction media, pre-filtering of suspended particles in the influent water can be achieved using a coarse-grained sand and gravel filter, which may be back-flushed to remove accumulated material. When overloading of the Treated red mud pellets occurs, the filtration/reaction columns may simply be dismantled the pellets extracted, replaced and disposed of. For an industrial plant several columns can be used in series and/or in parallel, so that fresh columns are available to treat effluent when others be come overloaded.

### Other Applications of the Porous Pellets According to the Invention

Pellets of the composition according to the invention may be used as gravel in a fish tank, ornamental pool or other water body, to remove nutrients or to prevent excessive algal growth.

In another embodiment of the invention, bags of pellets of the composition in accordance with the invention may be suspended in a water body or may be formed as a floating island to treat the water.

Mobile and stationary water treatment tanks may be provided, and the tanks may be filled with pellets of the composition according to the invention, to treat water either continuously or as required.

Alternatively, coarse gravel or cobble sized pellets may be placed directly in a flowing water body (e.g. in a creek), to neutralise acid or to remove metal contaminants.

The invention also extends to the provision of a column for the treatment of a gas containing a potentially acid forming substance such as an oxide of sulphur and/or nitrogen, or for the treatment of a gas to remove polar organic molecules.

In another embodiment of the invention, a porous pellet blanket, made of the composition in accordance with the invention is provided to control odour emissions.

Thus, by following the teachings of the present invention, stable, strong and porous particles of a composition comprising red mud can be made. These particles may be in the form of pellets, and they may have and retain a large surface area as well as a high acid neutralising metal binding capacity. The intrinsic permeability of these particles may allow flowing water to pass through and around the material. When dry, the dust forming propensity of these particles is low.

In accordance with an eighth aspect of the invention, there is provided a porous particulate material for treating a fluid containing a contaminant, the particulate material comprising a mixture of a cementitious material and a bauxite refinery residue.

The volume of the pores may be between 10% and 90% of the volume of the particulate material. At least 10% of the pores may be open cell or interconnected pores. The pores of the particulate material have a distributed pore size. The pore size of the particulate material is within the range of 0.1 to 2000 μm.

In accordance with a ninth aspect of the invention, there is provided porous particulate material for treating a fluid containing a contaminant, the particulate material comprising a coherent mass of particles, each of which comprises a mixture of a cementitious material and a bauxite refinery residue.

### Cementitious Compositions

According to a tenth aspect of the invention, there is provided a cementitious composition comprising partially neutralised red mud and cement, wherein the partially neutralised red mud has been pre-treated by contacting it with water having a total hardness supplied by calcium, magnesium or a combination thereof, of at least 3.5 millimoles per litre calcium carbonate equivalent.

In the pre-treatment of the red mud, its pH may be reduced to a value of at most about 10.5 and at least about 8.2. The pH of the red mud may conveniently be reduced to anywhere within the range of 8.2 to 10.5. It is preferably reduced to a value as low as possible within the aforementioned range. The pH may be reduced to about 8.5-10, or alternatively to about 8.5-9.5, or alternatively to about 8.5-9.5, or as another alternative, to about 9-10, or as a further alternative to about 9.5-10, or from about 9-about 9.5.

According to an eleventh aspect of the invention, there is provided a process for the manufacture of a cementitious composition comprising
(a) contacting red mud recovered from the Bayer Process with water having a total hardness supplied by calcium, magnesium or a combination thereof, of at least 3.5 millimoles per litre calcium carbonate equivalent, so as to obtain a partially neutralised red mud; and
(b) mixing the partially neutralised red mud with cement so as to obtain the cementitious composition.

In step (a), the pH of the red mud may be reduced to a value of at most about 10.5 and at least about 8.2. The pH of the red mud may conveniently be reduced to anywhere within the range of 8.2 to 10.5. It is preferably reduced to a value as low as possible within the aforementioned range. The pH may be reduced to about 8.5-10, alternatively to about 8.5-9.5, as another alternative, to about 9-10, as a further alternative to about 9.5-10, or from about 9-about 9.5.

The process according to the invention may include a step (a1), after step (a) and before step (b), in which the partially neutralised red mud is dried to obtain a dry solid material.

The process according to this aspect of the invention may include a further step (a2), after step (a1) and before step (b), in which the dry solid material of step (a1) is comminuted so as to obtain a partially neutralised dry, comminuted red mud.

The cement may be present in the composition in a concentration of from about 1 wt % to about 99 wt % and the partially neutralised red mud may be present in the composition in a concentration of from about 99 wt % to about 1 wt %.

The comminution in step (c) may be performed by crushing and/or pulverising. It may be performed by any crusher and/or pulveriser, which may be a cone crusher, a rod mill, a ball mill, a jaw crusher or an orbital crusher.

The invention also extends to a cementitious composition made by the process according to the invention.

Optionally, the process according to the invention includes a step, after step (a) and before step (b), of contacting the red mud with, or a partially reduced red mud with, an acid so as to perform part of the overall lowering of the pH of the red mud to at most about 10.5 and at least about 8.2.

As a further option, the process may include a step of separating a liquid phase from the red mud, or the partially reduced pH red mud, after step (a) and before step (b).

The water used in the pre-treatment of the partially neutralised red mud, in step (a) of the process according to the invention, should have a total hardness supplied by calcium plus magnesium of more than 3.5 millimoles calcium carbonate equivalent per litre. However, in order to reach the pH of less than 10.5, the water preferably has a total hardness supplied by calcium plus magnesium in excess of about 5 millimoles per litre calcium carbonate equivalent, more preferably, in excess of 10 millimoles per litre calcium carbonate equivalent, even more preferably, in excess of about 15 millimoles per litre calcium carbonate equivalent. The water conveniently has a base amount and a treatment amount of at least one of calcium and magnesium. The base amount for calcium is about 150 mg/L (1.5 millimoles per litre calcium carbonate equivalent) and the base amount for magnesium is about 250 mg/L (2.5 millimoles calcium carbonate equivalent). Although satisfactory results have been obtained with brine containing about 200 to about 300 mg/L calcium and from about 300 to about 750 mg/L magnesium, it was found that, for the treatment to work efficiently, concentrations exceeding 300 mg/L calcium and 750 mg/L magnesium are preferred. The concentrations that are best for any particular set of circumstances depend on the solubilities of various compounds that may be formed in the solution, the temperature of the solution and the service and environmental conditions under which the cementitious composition is to be used.

The water used for the pre-treatment of the partially neutralised red mud in step (a) thus preferably contains a significantly higher concentration of calcium and/or magnesium than is available in ordinary tap water. Regulations governing tap or drinking water quality usually include guidelines based on hardness (which is usually expressed as CaCO₃ equivalent). The total hardness (Ca hardness plus Mg hardness) of a drinking water should be less than 500 mg/L which is equivalent to less than about 5 millimoles per litre. Therefore, the combined concentrations of Ca and Mg should be less than about 5 millimoles per litre, which is very low compared to the Ca and Mg concentrations used for the neutralization or partial neutralization of red mud in step (a) of the process according to the invention. When water is hard, soaps and other detergents will not foam. Instead, a scum is formed on the water surface. A range of criteria for hardness may be as follows:

| | | |
|---|---|---|
| Soft water: | 0-59 | mg/L (0-0.59 mM) |
| Moderately soft water: | 60-119 | mg/L (0.6-1.19 mM) |
| Hard water: | 120-179 | mg/L (1.2-1.79 mM) |
| Very Hard water: | 180-240 | mg/L (1.8-2.4 mM) |
| Extremely Hard water: | >400 | mg/L (>4 mM) |

Water having a hardness of less than 60 mg/L has an increased corrosion potential on iron and steel fittings, pumps and pipes, whereas water having a hardness of more than 350 mg/L has an increased potential for fouling and scale formation. Consequently, to avoid the abovementioned undesirable effects, drinking water should have a total hardness not exceeding 350 mg/L (which is equivalent to about 3.5 millimoles of Ca plus Mg). A good quality drinking water preferably has a total hardness in the range of 60-180 mg/L (which is equivalent to about 0.6-1.8 millimoles of Ca plus Mg).

In step (a) of the process according to this aspect of the invention, the pH of the red mud is conveniently reduced to anywhere within the range of 8.2 to 10.5. The pH is conveniently reduced to about 8.5-10, alternatively to about 8.5-9.5, or alternatively to about 8.5-9, or as another alternative to about 9-10, or as a further alternative to about 9.5-10, or from about 9-about 9.5.

In step (a) of the process according to this aspect of the invention, the total alkalinity, expressed as calcium carbonate alkalinity, of the red mud may be reduced to about 200 mg/L-1000 mg/L, alternatively to about 200 mg/L-900 mg/L, alternatively to about 200 mg/L-800 mg/L, alternatively to about 200 mg/L-700 mg/L, alternatively to about 200 mg/L-600 mg/L, alternatively to about 200 mg/L-500 mg/L, alternatively to about 200 mg/L-400 mg/L, alternatively to about 200 mg/L-300 mg/L, alternatively to about 300 mg/L-1000 mg/L, alternatively to about 400 mg/L-1000 mg/L, alternatively to about 500 mg/L-1000 mg/L, alternatively to about 600 mg/L-1000 mg/L, alternatively to about 700 mg/L-1000 mg/L, alternatively to about 800 mg/L-1000 mg/L, alternatively to about 900 mg/L-1000 mg/L, preferably less than 300 mg/L.

In step (a) of this process, the pH is conveniently reduced to less than about 10.5, preferably to less than about 9.5, more preferably to less than about 9.0, and the total alkalinity, expressed as calcium carbonate equivalent alkalinity, is reduced to less than 300 mg/L and preferably reduced to less than 200 mg/L.

A preferred composition comprises from 50% to 95% by dry weight of partially neutralised red mud and from 5% to 50% by weight of cement. A more preferred composition comprises from 70% to 90% by dry weight of partially neutralised red mud and from 10% to 30% by dry weight of cement. A most preferred composition comprises from 80% to 85% by dry weight of the partially neutralised red mud and from 15% to 20% by weight of the cement.

In one embodiment of the invention, the composition comprises at least 30 wt % of partially neutralised red mud. In another embodiment, the composition comprises at least 50 wt % of partially neutralised red mud.

The inventors have found that cementitious compositions made with partially neutralised red mud maintain a high acid neutralising and metal binding capacity. These compositions are capable of treating acidity produced as a result of pyrite oxidation, or by any other means, and are sulfate resistant. The inventors also found that, up to certain limits, imposed by the demands of particular applications, partially neutralised red mud can act as a cement replacement that does not adversely affect the strength of the composition, and will adhere to steep rock faces so as to help stabilise them against potential rock falls. They further found that the composition according to the invention, when dry, does not produce an appreciable dust problem and is capable of being moulded into articles having very fine textural or surface detail.

The composition according to the invention may be used as a substitute for a conventional cementitious composition, without substantial reduction in strength.

The composition according to the present invention may be used to produce a castable material that has the ability to be moulded such that fine textural detail on the mould surface is transferred to and preserved on the mould surface.

In one embodiment of the invention, from 0.2 wt % to 3 wt % of the cement of a super-plasticizer for example MAPEI™ N10 and R14, MAPETAR™ or MAPEPLAST RMX may be added to the composition according to the present invention, to produce a shotcrete that has an enhanced acid neutralising capacity, that will trap heavy metals, and that is capable of being spayed onto vertical walls.

In another embodiment of the invention, additional water and from 0.2 wt % to 3 wt % of the cement of a super-plasticizer for example MAPEI™ N10 and R14, MAPETAR™ or MAPEPLAST RMX may be added to the composition according to the present invention, to produce a grout that can be pressure injected into rock or soil materials to increase their strength and reduce their permeability and to neutralise any acidity and trap any trace metals that may be present in pore fluids.

In another embodiment of the invention, the composition is extruded into porous pellets that are subsequently cured and dried. The dried pellets may then be used for acidic water remediation. Such remediation may be performed in an underground water duct or aquifer or else in a treatment vessel.

### Partially Treated Red Mud for Cementitious Compositions

The partially neutralised red mud for cementitious compositions may be prepared by at least partially reacting red mud from a bauxite refinery by the addition of calcium and/or magnesium ions in an aqueous solution, or by the addition of an acid; or by an injection of carbon dioxide or by adding a mineral such as gypsum, or by some combination of these procedures.

Alternatively, the partially neutralised red mud may be prepared by at least partially reacting red mud from a bauxite refinery with a material selected from the group consisting of a ferruginous residue recovered from titanium refining process, a ferruginous soil, a ferruginous rock material (such as fines produced as a by product of iron ore mining) or bauxite.

As described in International Patent Application No. PCT/AU03/00865, the contents of which are incorporated herein in their entirety, red mud from a bauxite refinery may be reacted with calcium and/or magnesium ions. Another way in which the at least partially neutralised red mud may be prepared is by reacting red mud from a bauxite refinery with a sufficient quantity of seawater, preferably seawater concentrated by evaporation, conveniently by solar action, to decrease the reaction pH of the red mud to less than 10.5. For example, it has been found that if an untreated red mud has a pH of about 13.5 and an alkalinity of about 20,000 mg/L, the addition of about 5 volumes of world average seawater will reduce the pH to between 9.0 and 9.5 and the alkalinity to about 300 mg/L. International Patent Application No. PCT/AU03/00865 furthermore teaches that red mud from a bauxite refinery may be reacted with calcium and/or magnesium ions by mixing one part of the red mud with 5 parts by weight of water containing a base amount and a treating amount of calcium ions and a base amount and a treating amount of magnesium ions, for a time sufficiently long to bring the reaction pH of the red mud to less than 10.5. The base amounts of calcium and magnesium ions are 8 millimoles and 12 millimoles, respectively, per litre of the total volume of the treating solution and the red mud. The treating amount of calcium ions is at least 25 millimoles per mole of total alkalinity of the red mud expressed as calcium carbonate equivalent alkalinity whilst the treating amount of magnesium ions is at least about 400 millimoles per mole of total alkalinity of the red mud expressed as calcium carbonate equivalent alkalinity. Suitable sources of calcium or magnesium ions include any soluble or partially soluble salts of calcium or magnesium, such as the chlorides, sulfates or nitrates of calcium and magnesium.

The general composition of partially neutralised red mud depends on the composition of the bauxite ore from which it derives, on operational procedures used at a refinery at which the bauxite is processed, as well as by how the red mud has been treated after production.

Neutralisation of raw red mud from a bauxite refinery is achieved when the addition of soluble Ca and Mg salts converts soluble hydroxides and carbonates into low solubility mineral precipitates McConchie, D., Clark, M. W., Fawkes, R., Hanahan, C. and Davies-McConchie, F., 2000. The use of seawater-neutralised bauxite refinery residues in the management of acid sulfate soils, sulphidic mine tailings and acid mine drainage. In: 3rd Queensland Environment Conference, 1, pp. 201-208, Brisbane, Australia. This procedure lowers the basicity to a pH of about 9.0 and converts most of the soluble alkalinity into solid alkalinity. More specifically, hydroxyl ions in the red mud wastes are largely neutralised by reaction with magnesium in the seawater to form brucite [Mg₃(OH)₆] and hydrotalcite [Mg₆Al₂CO₃(OH)₁₆.4H₂O], but some are also consumed in the precipitation of additional boehmite [AlOOH] and gibbsite [Al(OH)₃] and some reacts with calcium in the seawater to form hydrocalumite [Ca₂Al(OH)₇.3H₂O] and p-aluminohydrocalcite [CaAl₂(CO₃)₂(OH)₄.3H₂O].

Partially neutralised red mud contains abundant Al, Fe, Mg, and Ca hydroxides and carbonates to provide either tobermorite gel constituents for the setting of concretes, or provide appropriate additives to induce early setting of the concrete. Conversely, increased gypsum content within partially neutralised red mud can retard setting rates.

Where red mud from a bauxite refinery has been partially neutralised using sea water, or evaporatively concentrated sea water, or other calcium- and magnesium-rich brines, or soluble calcium and magnesium salts, or some combination of these options, the partially neutralised red mud still has a high acid neutralising capacity (2.5-7.5 moles of acid per kg of partially neutralised red mud). It also has and a very high trace metal trapping capacity (greater than 1,000 milliequivalents of metal per kg of partially neutralised red mud). It furthermore has a high capacity to trap and bind phosphates and some other chemical species. Partially neutralised red mud can be produced in various forms to suit individual applications (e.g. slurries, powders, pellets, etc.) but all have a near-neutral soil reaction pH (less than 10.5 and more typically between 8.2 and 8.6) despite their high acid neutralising capacity. The soil reaction pH of partially neutralised red mud is sufficiently close to neutral and its TCLP (Toxicity Characteristic Leaching Procedure) values are sufficiently low that it can be transported and used without the need to obtain special permits.

A particular benefit of using partially neutralised red mud in the compositions and methods of the invention is that the soluble salt concentrations, especially sodium concentrations, are substantially lower than those in untreated red mud. This effect can be particularly important where the salinity of treated waters to be discharged to environments that are sensitive to sodium or salinity increases, or where salinity of discharge waters to be used as irrigation waters may adversely affect plant growth, have a lower potential impact. Furthermore, decreased soluble salt concentrations contribute to increased final strength of cementitious compositions in accordance with the invention.

Concrete strength is dominated by the formation of tobermorite gel formation. Most typically, tobermorite gel is produced in the setting of an hydraulic cement. Hydraulic cements include ordinary Portland cement, high early strength Portland cement, low heat Portland cement, sulfate resisting Portland cement, high alumina cement and other commercially available cementing agents. In this specification, the expression “cement” is to be understood as including the aforementioned examples of hydraulic cement.

Within a tobermorite gel, four main constituents are usually present: tricalcium silicate (C3S), dicalcium silicate (C2S) tricalcium aluminate (C3Al) and tetracalcium alumino-ferrate (C4AlFe).

When red mud is partially neutralised (either by brine addition or by seawater or concentrated sea water addition, with or without supplementation by soluble magnesium and calcium salts), the alkalinity of the red mud is converted from a soluble form which is predominantly sodium carbonate and sodium-hydroxide into an insoluble form which is precipitated as solids as a series of alumino-hydroxy carbonates. The excess sodium is drained from the system with the remaining brine. The alumino-hydroxy carbonates act as a pH buffering system against acid attack. However, they also provide additional pozzolanic material such that cement, including OPC, may be partly substituted by partially neutralised red mud in a cementitious composition, without a significant reduction in strength of the composition.

Un-neutralised red mud (dried or wet) has a high Na content that is detrimental to the strength development of cementitious compositions. The monovalent alkali metals (Na and K) in such cementitious compositions interact with the tobermorite gel to produce Alkali-Aggregate Reactions, Alkali-Carbonate Reactions and Alkali-Silica Reactions (see www.pavement.com).

An Alkali-Aggregate Reaction is a chemical reaction in mortar or concrete between an alkali metal (sodium or potassium) released from Portland cement or from other sources, and certain compounds present in the aggregates. Under certain conditions, harmful expansion of the concrete or mortar may be caused by these reactions, which are detrimental to strength development.

An Alkali-Carbonate Reaction is a reaction between an alkali metal (sodium or potassium) and certain carbonate rocks, particularly calcite, dolomite and dolomitic limestones, present in some aggregates. The products of the reaction may also cause abnormal expansion and cracking of concrete in service.

An Alkali-Silica Reaction is a reaction between an alkali metal (sodium or potassium) and certain siliceous rocks or minerals, such as opaline silica, chert, chalcedony, flint strained quartz and acidic volcanic glass, present in some aggregates. The products of this reaction may also cause abnormal expansion and cracking of concrete in service.

The expansion and cracking induced by a high sodium content in cementitious composition could be exacerbated by the formation of silica gels, which can also lead to decreased final strength and a shortened service life.

Water washed (to remove a high proportion of the hydroxide red muds, although having a much reduced sodium content, also have little acid neutralising capacity. They are undesirable in cementitious compositions according to the invention because they do not contribute sufficiently to the acid neutralizing capacity of the cementitious compositions according to the invention. In addition, because there are no alumino-hydroxy carbonate minerals in these red muds (because they have not been precipitated with the addition of the Ca and Mg cations during neutralization), also lack the enhanced pozzolanic attributes of partially neutralized red mud incorporated in cementitious compositions according to the invention. By providing additional pozzolanic qualities and lowered sodium contents compared to un-neutralised red mud, unique and improved qualities are imparted to the compositions of the invention.

### Water and Cementitious Compositions

Water is important for hydration/activation of the tobermorite gel as well as for lubrication during mixing. The amount of water in the mix greatly affects mix consistency, workability and final strength. Too little or too much water both result in decreased strength. Too little water also results in workability difficulties. For strength, it is preferable to have the mixture slightly too dry than to have the mixture slightly too wet. For shotcrete, it is preferable to have the mixture too wet than too dry and for most grouting applications it is essential to use a wet mix. Water should be added to the dry ingredients and blended until a smooth paste develops. The preferred range of water to be added depends on the partially neutralised red mud blend used, the proportion of acid neutralising hydroxide and oxide minerals present in the blend, the initial water content of the partially neutralised red mud and the intended purpose of the final product.

For load bearing concrete, the preferred range for water addition is from 15% to 55% water to dry ingredients by weight, with a more preferred range of 25% to 45% water to dry ingredients by weight, an even more preferred range of 30% to 40% water to dry ingredients by weight, and a most preferred range of 33% to 37% water to dry ingredients, by weight.

For shotcrete, the preferred range for water addition is from 25% to 80% water to dry ingredients by weight, with a more preferred range of 35% to 75% water to dry ingredients by weight, an even more preferred range of 45% to 70% water to dry ingredients by weight, and a most preferred range of 50% to 60% water to dry ingredients, by weight.

For grout, the preferred range for water addition will depend on the equipment to be used, the porosity and permeability characteristics of the rock or soil material to be grouted and other technical factors, but in general it is from 25% to 98% water to dry ingredients by weight, with a more preferred range of 35% to 95% water to dry ingredients by weight, an even more preferred range of 45% to 90% water to dry ingredients by weight, and a most preferred range of 55% to 85% water to dry ingredients, by weight. More permeable receiving materials, larger pore sizes, lower pumping distances and larger injection pipe diameters require drier mixtures, whereas lower permeability receiving materials, small pores, long pumping distances and smaller injection pipe diameters favour wetter mixtures.

### Silica Providers and Cementitious Compositions

Additional silica sources may be included in the mix, to enhance tobermorite gel formation. These may include silica sand, diatomaceous earth, fly ash, bottom ash or crushed silicate rock. The additional silica source may be added either singly or as a combination. The preferred concentration of the added silica source is in the range of 0% to 30% by dry weight, a more preferred range is from 3% to 20% by dry weight, and a most preferred range is from 5% to 12% by dry weight.

### Plasticisers/Polymerisers

Plasticisers/polymerisers may also be added to the mix to provide greater workability of the wetted mixture, to inhibit initial setting time and to provide additional binding strength to the cured product. Plasticisers/polymerisers include, but are not limited to, Methocell®, cellulose ethers, methyl-hydroxyethyl-cellulose (MHEC), hydroxypropyl-methyl-cellulose (HPMC) and Bricky's Mate™. Highly substituted organic plasticisers/polymerisers are preferred for the addition to mixtures using partially neutralised red mud blends (e.g. HPMC). In low ionic strength systems (e.g. freshwater rinsed partially neutralised red mud) less highly substituted plasticisers/polymerisers may be used (e.g. MHEC). A preferred concentration of added plasticiser is in the range of 0% to 8% by weight of the dry mixture, a more preferred concentration is in the range of 0.1% to 5% by weight of the dry mixture, an even more preferred concentration is in the range of 0.2% to 3% by weight of the dry mixture, and a most preferred concentration is in the range of 0.3% to 2.0% by weight of the dry mixture.

### Air Entraining Agents

The entrainment of air provides increased porosity and permeability within the final product. Air entraining agent's work by increasing the trapping ability of air sheared into the concrete during mixing or through the release of gases under the chemical conditions of the slurry, during mixing and setting. The use of air entraining agents increases the concrete's ability to expand and contract, without cracking, and hence protects the final concrete product against repeated freeze and thaw action in cold climates.

Air entraining agents include, but are not limited to, hydrogen peroxide, organic polymers and commercially available organic foaming agents (e.g. EP2021™). Hydrogen peroxide breaks down under the chemical conditions of the slurry. It releases oxygen that expands to provide porosity. The migration of gas bubbles provides pellet permeability via interconnected porosity. Air entraining agents are not affected by the vibro-compaction of the slurry during moulding.

Hydrogen peroxide may be used as an air entraining agent, in varying strengths. The strength is preferably in the range of 0.1% to 75% weight to volume hydrogen peroxide, more preferably between 1% to 30% weight to volume, and most preferably between 3% to 10% weight to volume. For a 3% weight to volume strength, addition rates are preferably between 1 mL and 25 mL per kg of dry mixture, more preferably between about 2 mL and about 20 mL per kg of dry mixture, even more preferably between about 5 mL and about 15 mL per kg of dry mixture, and most preferably between about 8 mL and about 10 mL per kg of dry mixture. Higher addition rates or higher concentrations of the air-entraining agent provide greater porosity and permeability, but lower physical strength.

### Phosphatising Agents

The development of apatite like minerals and/or phosphate cross-linking between mineral crystals may provide additional strength benefits, especially wet strength. Phosphate may also act to trap and bind heavy metals. Phosphatising agents may therefore be added to the mixture and may include phosphoric acid, tri-sodium phosphate, di-sodium hydrogen-phosphate, sodium di-hydrogen phosphate, tri-potassium phosphate, di-potassium hydrogen-phosphate, and potassium di-hydrogen phosphate. Phosphoric acid with a preferred strength between 0.01 M to 18 M may be used, more preferably a phosphoric acid strength of 0.1 M to 5 M may be used, and even more preferably a phosphoric acid strength of 0.5 M to 3 M may be used. A most preferred phosphoric acid strength is 1 M to 2 M. At a phosphoric acid strength of 1.5 M, an addition rate of 0.2 mL to 4 mL per kg of dry ingredients may be used, a more preferred addition rate is 1 mL to 3.5 mL per kg of dry ingredients, a still more preferred addition rate is 1.5 mL to 2.5 mL per kg of dry ingredients, and a most preferred rate is 2 mL to 2.5 mL per kg of dry ingredients.

### Organic Matter

The incorporation of organic matter during formation of a cementitious composition can provide a fibrous mat, while the xylem and phloem of the tissue can provide additional interconnecting pathways for fluid flow. In addition, organic matter may provide a suitable bacteria growth medium. The formed products may be used in anaerobic treatments, of efficient, and may allow biogeochemical reactions (e.g. sulfate reduction, and denitrification) to progress efficiently. Organic matter that may be incorporated into the product include, but is not limited to, sewage biosolids, sugarcane bagasse, straw chaff, mulch, and hemp fibres. The concentration of added organic matter may be in the range of from 0% to 15% by weight of the dry mixture. A preferred concentration is in the range of 0.4% to 10% by weight of the dry mixture, an even more preferred concentration is in the range of 0.6% to 8% by weight of the dry mixture, and a most preferred concentration is in the range of 0.8% to 5.0% by weight of the dry mixture,

### Reinforcing

Reinforcing of large structures and concrete pours may be necessary where the concrete will be load bearing, especially under tensile stress. Most typically, reinforcing of concrete is achieved using steel reinforcing. However, chloride ingress and steel corrosion often leads to a breakage of the concrete, because of corrosion swelling around the reinforcing rods. Consequently, conventional reinforcing steel is often galvanised, or epoxy coated to isolate the steel from the corroding salt. Alternatives to this are the use of cathodic protection by inducing a current so that the steel is cathodic. Another alternative is to use corrosion resistant steels (e.g. stainless steel), or non-steel alternatives such as glass fibre, aramid fibre, carbon fibre, polypropylene fibre or polyethylene fibre. Fibres may be added to the concrete as short fibres (approximately 50 mm length) to provide a cross-linked mat for the concrete to set around and to provide improved strength.

### Set Accelerants

A set accelerant may be added to the cementitious composition according to the invention to provide rapid setting, by promoting the formation of C3A, C4AF components in the composition or by inducing other high water demand mineral growth. However, the initial acceleration of the setting process of a cementitious composition often has a trade off, in that the final strength thereof may be reduced. Set accelerants are typically, but not always, inorganic in nature and may provide compounds that are utilised in the early stages of setting, or that produce water-demanding products. Set accelerants include, on the inorganic side, alkali metal (K, Na & Li) hydroxides, oxides aluminates and carbonates, alkali-earth metal (Ca & Mg) hydroxides, oxides, aluminates, or carbonates, fumed silica, silicic acid, ferric salts (including chloride, nitrate and sulfate), and montmorillonite clays, or, on the organic side, N,N-dimethylacrylamide, AMIS, RMT, naphthalenesulfonic acid and formaldehyde.

### Set Retardants

A set retardant may be added to slow down the initial setting of the cementitious composition. A common set retardant is gypsum (calcium sulfate dihydrate). It may have been added to the hydraulic cement specifically for this purpose. By retarding the set time of the concrete, it allows for a much longer working time for smoothing, working, and pouring of the concrete. This is especially important when a single continuous large pour is required. In addition, by slowing the setting process down, there is less likelihood of cracking and shrinkage of the concrete. Gypsum may be used in combination with tri-ethanolamine, to prevent shrinkage.

### Salt Resisting Agents

Salt resisting agents aid in protecting the set product against saline waters. Concretes with a low C3A content are more resistant to sulfate attack. By including an additive that shifts the setting structure away from C3A to C4AF, C2S, C3S and other compounds such as CA, C3A4 (tri-calcium tetra-aluminate), and C2AS (di-calcium alumino-silicate) greater salt protection can be obtained. In order to achieve greater salt resistance, ferric salt or calcium aluminate may be added to the composition. Some plasticisers could be affected by the salinity of the mix water, decreasing their performance. For example, MHEC (methyl-hydroxy-ethyl cellulose has a low salt tolerance and the strength provided in low salt environments is lost when mixed in a high salt environment. However, this can be overcome by using a high salt tolerant variant HPMC (hydroxy-propyl methylcellulose).

### Other Additives

Other components may be added to the mix, as desired, to change the geochemical and physical characteristics of the final product and may include, but are not to be limited to, silica providers, plasticisers, phosphatising agents and air entraining agents.

### Mixing of Ingredients

Dry materials may be sieved, preferably to <2 mm, more preferably to <1 mm, even more preferably to <500 μm and most preferably to <250 μm. They are preferably fully mixed to reduce material clumping. Wet materials (water, any phosphatising agent, and any air entraining agent) are preferably mixed together before addition to the dry materials. They may alternatively be added individually. If the wet ingredients are to be individually mixed with the dry ingredients then the mixing order may be water before the phosphatising agent, before the air entraining agent. Extended mixing of the slurry (i.e., going from a slightly wet to slightly dry slurry) may be performed, to ensure complete entrainment of air during the mixing process as air entrainment is substantially reduced once mixing is stopped. The phosphatising agent may be phosphoric acid. The air entraining agent may be hydrogen peroxide.

Mixing can be achieved by a number of means, including by commercially available shear-force mixers, and concrete mixers that turn over the materials. When the materials are mixed, mixture is preferably folded in on itself for at least 5 minutes, preferably for at least 10 minutes, at a rate of at least 10 times per minute, preferably at a rate of at least 20 times per minute, and more preferably at a rate of at least 30 times per minute. (These rates may be the same as the revolutions per minute for commercially available concrete mixers). A shear-force mixer (such as a bread mixer) may be used at higher mixing rates than standard concrete mixers. Depending on the machine specifications, mixing times may be adjusted accordingly.

### Pouring, Moulding and Drying

Optimum concrete strength is usually attained after curing for about 28 days. However, curing will continue for many months and even years. Initial setting of cement is achieved by the development of the C3Al and C4AlF forms of tobermorite, over a period of 0-10 days. The C3S and C2S tobermorite gel usually forms over a period of 0-400 days.

To maximise strength, the poured product is preferably maintained in an environment that restricts moisture loss, for a period of at least 28 days before use. During curing, temperatures are preferably kept as cool as practicable, to minimise loss of water, and to promote C3S tobermorite development. The product is preferably allowed to cure for at least 28 days to provide for the development of a C3S tobermorite gel, to form a product that has a low quantity of fines (<0.15 mm) and a low potential for creating a dust problem.

### Hebel Concrete

Hebel concrete is a highly porous, lightweight concrete which is used for weight saving in non-load bearing wall constructions. Typically, it is moulded into blocks, but it can be poured into large slabs and lifted into position. The method of manufacture is the same as for a typical concrete except that a foaming (extreme air entraining) agent such as EP2021, is added. Upon mixing, EP2021 foams much like shaving cream to provide a very porous cement composition that sets while preserving the porosity. Because of its porosity, Hebel concrete has a high capacity to store water therefore is ideal for concrete planter boxes and the like.

### Shotcretes

A shotcrete that can be sprayed onto walls and ceilings may be prepared by the process in accordance with the invention. To accomplish this, a super-plasticizer may be added to a composition according to the invention, in order to improve the pumpability of the ultimate shotcrete composition, when it is prepared for use by adding water to cause the formation of a tobermorite gel that will adhere to a vertical wall when sprayed thereon. The hydrated mixture, which preferably contains no more water than is necessary to facilitate efficient pumping of the mixture, is then pumped and sprayed on to the vertical wall, through a spray nozzle. Just prior to emerging from the spray nozzle, a set accelerant is added to the already hydrated composition. For some applications, fibre reinforcing may also be added at this point. The set accelerant causes rapid setting of the sprayed concrete before it can slump from the wall. Typically, the set accelerant is a dry powder such as fumed silica, an alkaline earth or an alkaline metal hydroxide.

### Grouts

Grouts to be used in environmental applications such as sealing leaks in rock or soil material near dams or other structures where it is necessary to keep water either in or out. The compositions according to this invention are particularly useful where the fluids to be controlled by the grouting process are acidic, caustic, saline, acidic and saline, or caustic and saline. The exact grout mixture required will depend on the geotechnical properties of the rock or soil to receive the grout, the equipment to be used to emplace the grout and the composition of the water to be controlled by the grouting process. Workability and setting characteristics are particularly important in determining grout composition, but strength is less critical because most of the strength requirements will be met by the rock or soil material being grouted and any additional strength resulting from grout emplacement will usually be comparatively small.

It is suggested that an ideal grout is selectable on three properties: the ingredients, the grout solution and the properties of the final product. The ingredients of the grout should be a material readily mobile in water that is inexpensive and derived from abundant supply, that is fine grained for ease of penetration; is stable at all anticipated storage conditions and is non-toxic, non-corrosive, non-flammable, or non-explosive. The grout solution should be able to achieve a viscosity similar to water that is stable under all normal temperatures, is catalysed with common, non-expansive chemicals, which is insensitive to dissolved salts commonly found in groundwater, has a stable pH, and has a readily and easily variable gel time. The resultant end product from the grouting process should therefore be, permanent, unaffected by chemical conditions normally found in groundwater, and be of high strength. Clearly these are a difficult set of criteria to meet, and no grout currently available can lay claim to all of these attributes. However, the properties critical to individual projects and/or sites will inevitably void the relevance of one or more of the above criteria and enable suitable grout selection.

### BRIEF DESCRIPTION OF THE DRAWINGS

In the accompanying drawings, FIGS. 1 through to 6 are Scanning Electron Microscope (SEM) images of pellets of a composition according to the invention; as follows:

FIG. 7 shows a schematic diagram of an exemplary laboratory apparatus that was used to obtain the results disclosed in Example 2 below.

FIG. 8 shows a schematic diagram of an exemplary industrial process to treat contaminated water using pellets having a composition according to the invention.

FIG. 9 shows cross-sectional view of a sub-surface permeable reactive barrier that utilises pellets according to the invention.

### DETAILED DESCRIPTION OF THE DRAWINGS

FIG. 1 is an SEM image of one pellet of a composition according to the invention, showing the distribution of macro-pores developed during pelletisation thereof. The image shows the distribution of macro-pores developed during the pelletisation process.

FIG. 2 is an SEM image of the pellet of FIG. 1, showing the detail of fine pores therein. It can be seen from FIG. 2 that the pellets have a highly distributed pore size. The macro-pore size is on the order of 20 to 100 μm in size and micro-pores on the order of 0.2 μm to 1 μm connect between then, through the walls. Macro-pore sizes of up to 2000 μm have been achieved in other experimental results.

FIG. 3 is an SEM image of the pellet of FIGS. 1 and 2, showing a fine interconnected tobermorite gel forming part thereof. FIG. 3 shows the fine interconnected tobermorite gel of the pellet 1. Large rhombohedral crystals are CaCO₃, crystallised from the pore water during curing.

FIG. 4 is an SEM image of the pellet of FIGS. 1 to 3, showing the collapsed tops of two carbonate filled macro-pores.

FIG. 5 shows an SEM image of pellet 2 showing the distribution of macro-pores developed during the pelletisation process.

FIG. 6 is a high resolution image of the surface of pellet 2, showing the micro-pore network that permeates the pellet.

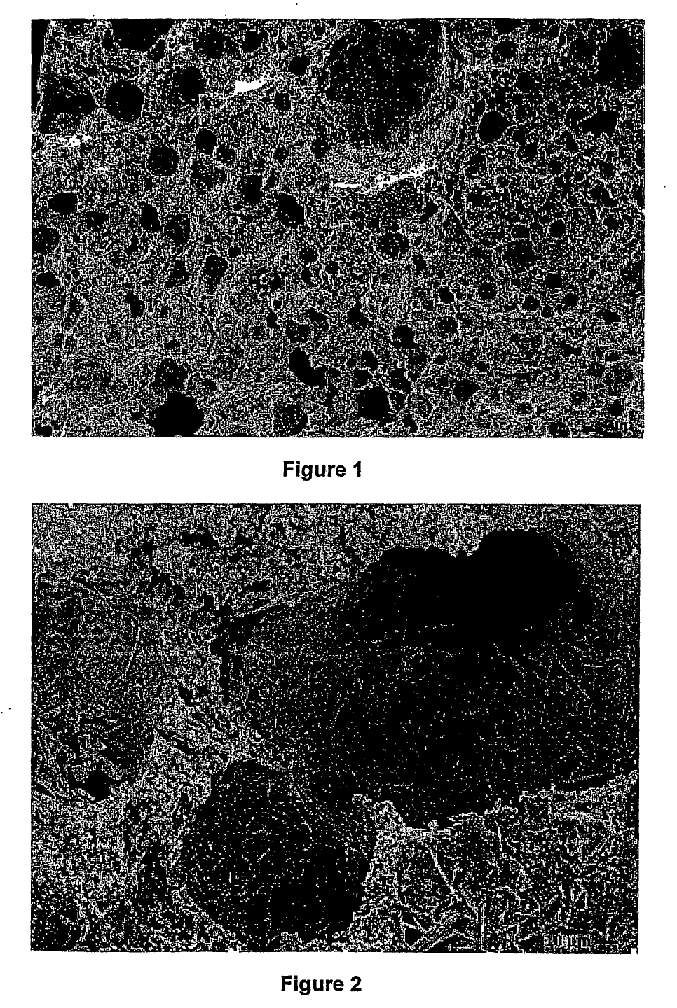

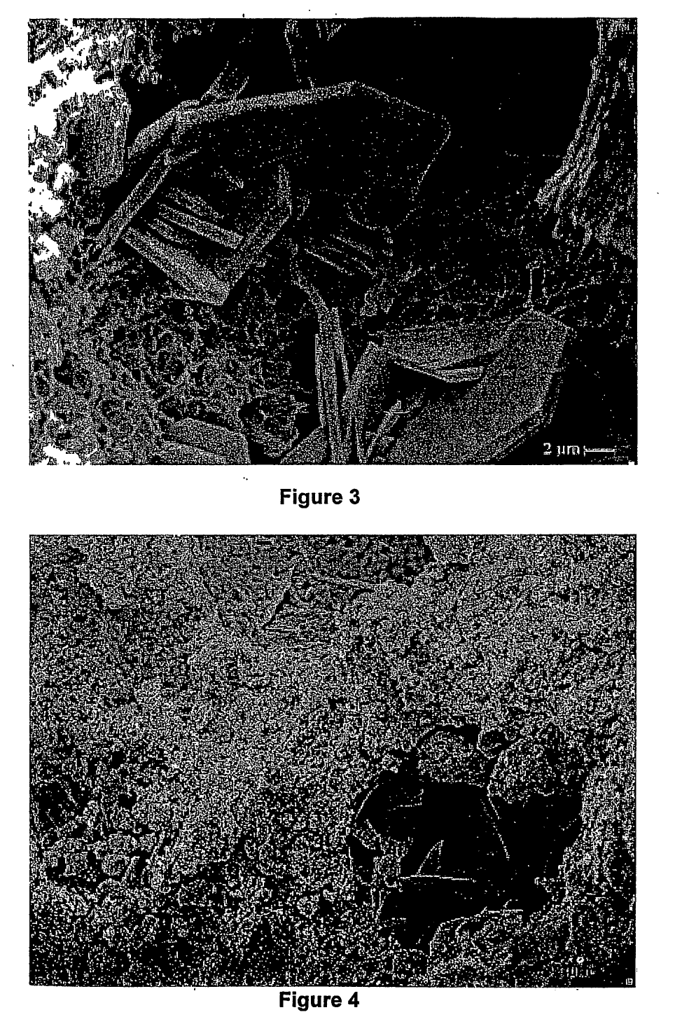

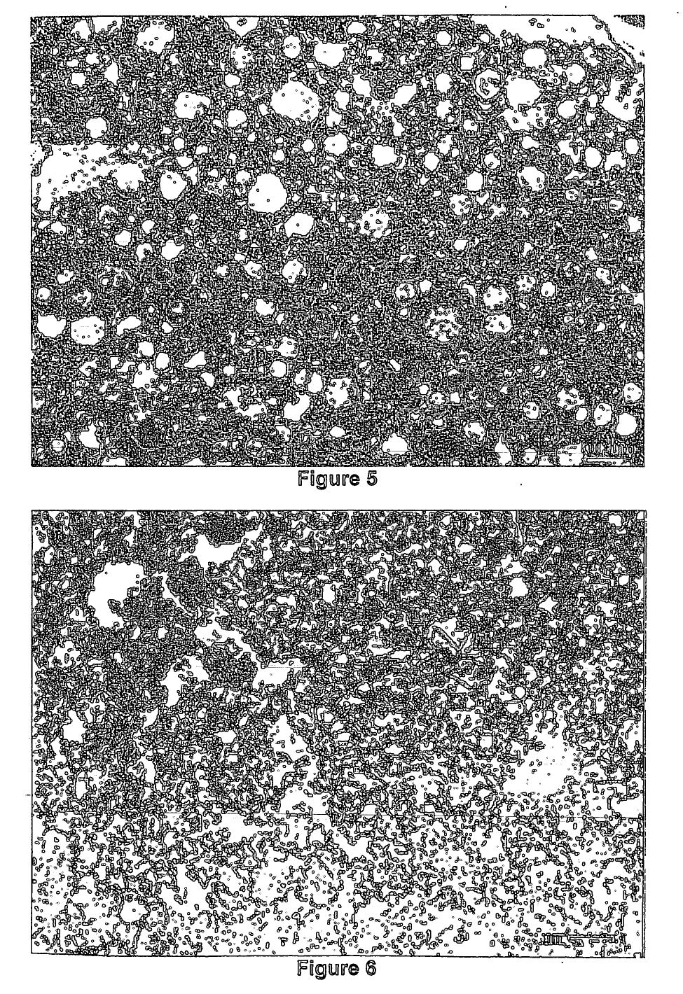

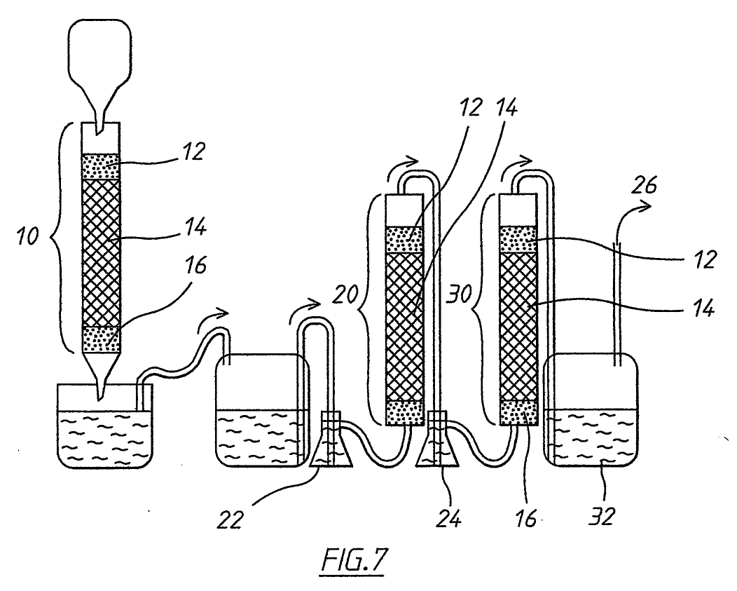

FIG. 7 is described below in relation to Example 2.

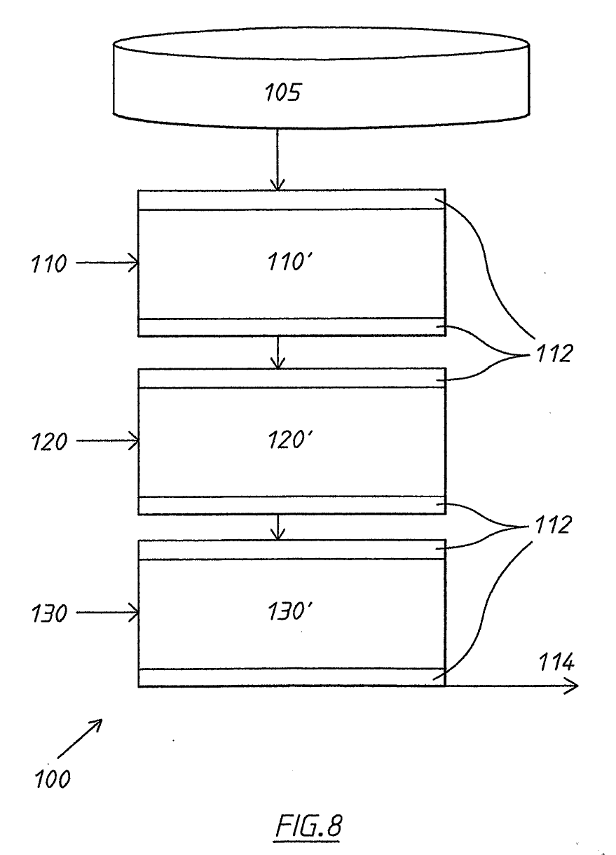

FIG. 8 is described below in relation to Example 5.

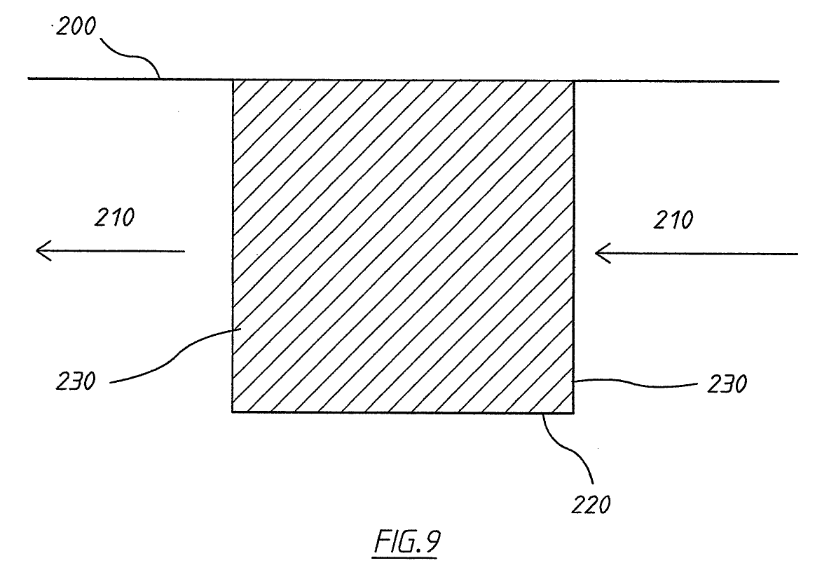

An exemplary industrial implementation of a sub-surface permeable reactive barrier is described below with reference to FIG. 9.

### EXAMPLES

### Porous Particulate Material

### Example 1

### Scanning Electron Microscope Investigation of Internal Porosity of Developed Pellets

Two pellets were made using the following methodology.
Pellet 1 was made by mixing the following components to form a slurry

80 g treated red mud

4 g hydrated lime

4 g magnesium oxide

2 g HPMC plasticiser/polymeriser,

15 g portland cement;

8 g silica sand of dry ingredients

70 mL of water,

8 mL of 3% H₂O₂, and

0.22 mL of 1.5M H₃PO₄

The above components were mixed in a shear-force mixer for one minute. The wet slurry was poured into a mould with a height to diameter aspect ratio of 3.5:1 and was restrictively capped and allowed to cure for 28 days.

Pellet 2 was made by mixing the following components to form a slurry:

70 g treated red mud

2 g HPMC plasticiser,

15 g Portland cement,

13 g of silica sand

70 mL of water,

0.8 mL of 3% H₂O₂, and

0.22 mL of 1.5M H₃PO₄,

The above components were mixed in a shear-force mixer for one minute. The wet slurry was poured into a mould with a height to diameter aspect ratio of 3.5:1, which was restrictively capped and allowed to cure for 28 days.

After 28 days the moulds were opened and samples of the pellets inspected under the scanning electron microscope, to investigate the fine textural, and structural characteristics.

The attached SEM images FIGS. 1 to 6, show the porous nature of the pellets and the lattice network of fine grained minerals making up the structure, and the presence of acid neutralising minerals within pore spaces that developed during pelletisation.

### Example 2

### Treatment of a Metal-Rich Tannery Effluent Using a Column Constructed of Porous Pellets

Referring to FIG. 7, there is shown a schematic diagram of laboratory apparatus that was use to obtain the results of Example 2. This trial used pellet 1, as given in Example 1 above, which was lightly crushed and sieved to give material in 4 grainsize ranges, of 250 μm to 500 μm, 500 μm to 750 μm, 750 μm to 1000 μm, and 1000 μm to 2000 μm. A pellet mix each of 25% of each of the 4 grainsizes was made to provide the filtration/reaction column (10). Three filtration/reaction columns (10, 20, 30) were constructed using polycarbonate tubing with an internal diameter of 44 mm. Each column (10, 20, 30) was sealed at one end and was packed with a 10 cm long coarse sand and gravel mixture (12) to act as a pre-filter, a geotextile wadding, a 5 cm long section of treated red mud pellets (14) another geotextile wadding (16), an other 10 cm long coarse sand and gravel pack to hold the treated red mud pellets (14) in place. The filtration/reaction columns (10, 20, 30) were and set up in series with a settling/precipitation vessel (22, 24) between each column

The tannery effluent was drawn through the columns under a 600 Mpa vacuum (26) where it was collected in a settling/precipitation vessel (32) for analysis and comparison to data for the direct addition of treated red mud to the same effluent. The total mass of treated red mud pellets in the reaction/filtration columns (10, 20, 30), was equal to the quantity of treated red mud added in a direct addition experiment. Effluent analysis, direct addition results and reaction/filter column results are presented in Table 3 below. Table 3 presents data from the treatment of tannery effluents using developed porous pellets, in a filter tube (reaction column).

TABLE 3
Results for the direct addition of treated red mud to a tannery effluent,
and the treatment of the same effluent using pellet 1 of example 1

| | | | Direct Addition | | Column |
|---|---|---|---|---|---|
| Parameter | Raw Effluent | Direct addition | Removal % | Column | Removal % |
| PH | 2.41 | 8.06 | — | 8.03 | — |
| TSS (mg/L) | 490 | 47 | 90.44 | 5 | 98.98 |
| BOD (mg/L) | 327 | 118 | 63.88 | 29.4 | 91.01 |
| Total P (mg/L) | 3.54 | 0.160 | 95.47 | 0.063 | 98.22 |
| Total N (mg/L) | 59.52 | 14.06 | 76.37 | 20 | 66.40 |
| Na (mg/L) | 810 | 824 | −1.71 | 538 | 33.58 |
| K (mg/L) | 817 | 1388 | −69.93 | 26.3 | 96.78 |
| Mg (mg/L) | 1520 | 7757 | −410.34 | 902 | 40.66 |
| Ca (mg/L) | 186 | 506 | −172.13 | 460 | −147.31 |
| Sulphate (mg/L) | 9310 | 7237 | 22.26 | 3390 | 63.59 |
| Chloride (mg/L) | 1844 | 1198 | 34.99 | 992 | 46.20 |
| Al (mg/L) | 384 | 0.134 | 99.97 | 0.0001 | 99.99997 |
| Cr (mg/L) | 53.7 | 0.33 | 99.39 | 0.0009 | 99.998 |
| Cu (mg/L) | 16.2 | 0.014 | 99.91 | 0.008 | 99.95 |
| Fe (mg/L) | 106 | 0.542 | 99.49 | 0.0002 | 99.9998 |
| Mn (mg/L) | 96.7 | 9.35 | 90.33 | 4.260 | 95.59 |
| Ni (mg/L) | 9 | 0.089 | 99.01 | 0.023 | 99.74 |
| Zn (mq/L) | 21.7 | 0.132 | 99.39 | 0.046 | 99.79 |

TSS denotes total suspended solids and BOD denotes the 5 day biochemical demand.

### Example 3

### Directions for Making Batches of Porous Pellets in a 4 m³ Cement Mixer

### Ingredients

2000 kg of A1 treated red mud screened to <2 mm
400 kg of ordinary portland cement:
250 kg of finely ground silica sand:
100 kg of hydrated lime screened to <1 mm:
200 kg of magnesium oxide screened to <1 mm:
50 kg of hydro-propyl methyl cellulose (HPMC) plasticiser:
About 2000 L of water:
25 L of 3% hydrogen peroxide (H₂O₂):
7 L of 1.5 M orthophosphoric acid (H₃PO₄):
Total weight of dry products: 3,000 kg
Total weight wet products: about 2,032 kg
Total wet weight: about 5,032 kg (2 m³)

It should be appreciated that it is optional to use dry treated red mud as indicated above. Treated red mud with a moisture content of about 50% could be used instead, but the amount of water to be added would need to be reduced in direct proportion to the amount of water included with the treated red mud. Washed treated red mud is not required but the treated red mud must be treated. For example, if the treated red mud to be used is supplied as a 50% slurry only the dry additives and a small amount of water would be required. Using the treated red mud as a screened slurry would eliminate the time and cost associated with drying it and could thereby overcome the main bottleneck in treated red mud production.

The ingredients above are for production of a general purpose treated red mud C5T10 blend. Other blends can be produced but mixtures may need to be adjusted carefully and a small amount of hydrated lime and magnesium oxide may need to be retained to ensure that a calcium or magnesium deficiency or a high sodium to calcium plus magnesium ratio does not adversely affect setting characteristics.

### Example 4

### Process Steps for Making Pelletised Composition

Step 1: Add 400 L of water to the mixer then add 2 t of the screened treated red mud and allow it to mix until a dry paste has formed.
Step 2: While mixing, dilute 1 L of phosphoric acid with 10 L of water, add it to mixer and allow mix for 15 mins.
Step 3: Add 400 kg of cement to the mixer and mix for 15 mins with an additional 400 L of water. A small amount of detergent can be added to improve for lubrication if necessary.
Step 4: While continuing to agitate the main ingredients, vigorously mix 200 kg of magnesium oxide and 100 kg of hydrated lime with 300 L of water in an IBC for 10 mins.
Step 5: Add the pre-mixed lime and magnesium oxide to the main mixer and allow to mix for 10 mins.
Step 6: While continuing to agitate the ingredients, mix 25 kg of HPMC with 150 L of hot water in an IBC and mix vigorously for 5 mins and then dilute to 300 L and mix for a further 5 mins.
Step 7: Add the pre-mixed polymer to main mixer and allow to mix for 10 mins.
Step 8: Repeat steps 6 and 7
Step 9: Add water (<300 L depending upon treated red mud water content) to the mixture until the desired consistency is achieved (a simple indicator test is currently being developed).
Step 10: While continuing mixing, dilute 2 L of the hydrogen peroxide with 23 L of water, add the diluted hydrogen peroxide to mixer and mix for 5 mins.
Step 11: Pour the mixture into slab between 100 mm and 200 mm thick; formwork should be set up in advance to hold the desired quantity of mix.
Step 12: Allow poured slab to gel for 36 hours and then stamp it into long rectangular blocks that can easily be lifted and stacked until cured and required for crushing.
Step 13: Allow stamped blocks to set for 7-10 days before stacking for final curing.
Step 14: Allow stacked blocks to cure for another 21 days minimum if using impact crushing or another 7 days if using a cutter (e.g. a wood chipper) to break the slab into pellets.

### Example 5

### Industrial Applications

The pellets made as described in any one of the examples 1 to 4 above can be used in an industrial process to remove contaminant from fluids that contain contaminants.

An exemplary industrial application is shown in FIG. 8, which is a schematic diagram of an industrial process (100) to treat contaminated water. The process (100) includes a feed tank (105) that holds contaminated water. The feed tank (105) supplies the contaminated water via a feed line to a train of contaminant removal tanks (110, 120, 130). Each of the contaminant removal tanks (110, 120, 130) are packed with a permeable mass of pellets (110′, 120′, 130′) that are made as described in any one of the examples 1 to 4 above. The permeable mass of pellets (110′, 120′, 130′) when packed within the contaminant removal tanks (110, 120, 130) have a porosity ε of about 60%. The permeable mass of pellets (110′, 120′, 130′) are packed between two sand porous sand layers (112) which have a particle size in the range of 3-5 mm and acts as a filter. The permeable mass of pellets (110′, 120′, 130′) are contained within a wire mesh net (not shown) for removal from the contaminant removal tanks (110, 120, 130). In use, water containing the contaminant is evenly disbursed by a spray (not shown) onto the upper sand layer (112) of tank (110). The highly porous pellets (110′) assist in the removal of at least some of the contaminant present in the feed water as has been described above. The feed water then passes successively through the remaining permeable mass of pellets (120′, 130′) located in respective tanks (120, 130) to successively remove additional contaminant from the water, which is ultimately removed from tank 130′ as shown by arrow 114.

It will be appreciated that variables of the process (100) such as water contaminant flow rate may be altered according to the concentration of contaminant in the water of feed tank 105.

It will also be appreciated that in other embodiments, tanks (110, 120, 130) may be substituted for columns and that the fluid may be a gas containing contaminant.

Another exemplary industrial application is shown in FIG. 9, which is a cross-sectional view of a sub-surface permeable reactive barrier (220) which is used to treat contaminated water. The sub-surface permeable reactive barrier (220) is comprised of a mass of pellets made according to any one of the examples 1-4 described above. The permeable reactive barrier (220) is disposed within a trench as shown by trench walls (230). The permeable reactive barrier (220) is disposed below the soil surface (200) in the path of water containing contaminant (210). The water (210′) that has passed through the permeable reactive barrier (220) has a lower contaminant concentration than the inlet water (210).

It will be appreciated that because the treated red mud has been made into pellets, it is easy to handle. The pellets also are highly permeable but do not forms any fine red dust when dry (unlike red mud), thereby making the pellets suitable for treating flowing acid waters, metal-rich waters and waters in areas near population centres, as well as gaseous emissions. It will also be appreciated that the pellets can also be used in permeable reactive barriers or passive water treatment columns or tanks where it is necessary to maintain moderate permeabilities.

The pellets also overcome the problems associated with the loss of fine red mud particles down stream.

While this invention has been described in specific detail with reference to the disclosed embodiments, it will be understood that many variations and modifications may be effected within the spirit and scope of the invention as described in the appended claims.

### Example 6

### Cementitious Compositions According to the Invention

TABLE 4

| | | | | Partially | |
|---|---|---|---|---|---|
| | | | | neutralised | |
| Sand | Gravel | Cement | Other* | Red Mud | Purpose |
| 0-1 | 0 | 1 | 0-2 | 2-5 | Constructive |
| | | | | | Concrete |
| 1-2 | 0-1 | 1-2 | 0-3 | 6-8 | Acid |
| | | | | | Resistant |
| | | | | | Concrete |
| 1-2 | 0 | 1 | 0 | 1 | Paver |

*other components include but are not limited to fly ash, silica fume, plasticizer, phosphoric acid, air entraining agents and reinforcing fibres.

### Example 7

### Further Cementitious Compositions According to the Invention

TABLE 5

| | | | | Partially | |
|---|---|---|---|---|---|
| | | | | neutralised | |
| Sand | Gravel | Cement | Other* | Red Mud | Purpose |
| 0-15 | 0-5 | 1-15 | 0-10 | 1-50 | Specialist |
| | | | | | Shotcrete |
| 0-10 | 0-5 | 1-20 | 0-5 | 1-30 | Hebel |
| | | | | | Concrete |
| 1-4 | 1-4 | 1-3 | 0-2 | 1-3 | Construction |
| | | | | | Concrete |

*other components include but are not limited to fly ash, silica fume, plasticizer, phosphoric acid, air entraining agents and reinforcing fibres.

### Example 8

### Partially Neutralised Red Mud as a Pozzolan (Cement Replacement) in Cementitious Paste

Four paste mixtures, respectively designated A, B, C and D, were prepared. Mixture A was prepared according to Australian Standard AS 1315. Mixtures B, C and D were prepared in a similar manner, except that instead of using 100% Ordinary Portland cement (OPC), these mixtures were prepared by mixing ordinary Portland cement (OPC) with increasing percentages of a slurry of partially neutralised red mud, of which the pH had been reduced to between 8.2 and to 10.5 by reacting red mud with an aqueous solution having a hardness supplied by calcium plus magnesium of greater than 5 millimoles calcium carbonate equivalent. The slurry contained approximately 51% solids.

The amounts of OPC replaced with partially neutralized red mud were as listed in Table 6.

The percentages replaced were respectively 5%, 10% and 20%. All four mixtures were 25 mm cubes, and all four mixtures were cast at a water to binder ratio of 0.45.

All four mixtures were allowed to cure continuously in sealed plastic bags stored in a fog room at 23° C. for 56 days and samples of each were then tested for compressive strength. The results were as follows:

TABLE 6

| | | | Initial | Compressive |
|---|---|---|---|---|
| | % partially | | setting | stress |
| | neutralized | | time | after 56 |
| Mixture | red mud | Flow (mm) | (minutes) | days (MPa) |
| A | 0 | 220 | 275 | 82 |
| B | 5 | 220 | 325 | 73 |
| C | 10 | 205 | 305 | 73 |
| D | 20 | 150 | 320 | 62 |

The final setting times were between 300 and 340 minutes with no discernable difference between the various mixtures.

In the case of mixture A (100% OPC), the compressive strength of the cured paste was 70 MPa after 28 days, whereas in the case of mixture D (20% replacement of OPC with partially neutralized red mud), the compressive strength of the cured paste, after 28 days, was 60 MPa.

The semi-adiabatic temperature of the cured paste (after 28 days) in the case of 100% OPC was 42° C., whereas the semi-adiabatic temperature of the cured paste (after 28 days) in the case of a 20% replacement of OPC with partially neutralized red mud, was 48° C.

The flow or slump of each of the mixtures was measured five minutes after mixing. The pastes of mixtures A, B and C were very fluid. However, the paste of mixture D (20% partially neutralized red mud replacement of OPC) was considerably less.

Workability describes the ease with which a paste or concrete can be mixed and placed to give a uniform material. There is no single measure of the property and in this example a modified flow test was used in terms of which the material was compacted into a conical container which was then lifted on one side and the resulting flow of the material was measured. The higher flow indicated a more fluid paste.

Setting times for the pastes were determined according to Australian Standard AS 1315. The addition of partially neutralized red mud resulted in an increase in initial setting times for mixtures B, C and D of 18%, 10%, and 17% respectively. This was considered to be an insignificant variation, when compared to the 100% OPC control mixture A.

The final setting times of the mixtures were between 300-340 minutes with no discernible difference between the reference and test formulations.

The initial and final setting time measurements of pastes represent specified resistances to the penetration of a needle. There are several variables influencing the penetration of the needle and in this example all parameters were kept constant except for the content of the partially neutralized red mud in the hydrating paste.

Mixtures A, B and C displayed continuous strength development up to 56 days curing, whilst mixture D (20% partially neutralized red mud, 80% OPC) appeared to achieve marginal strength gain after an initial period of 7 days of fog cure.

### Example 9

### Partially Neutralised Red Mud as a Pozzolan (Cement Replacement) in Concrete

Two mixtures of cementitious compositions intended for use as general purpose concrete having a nominal compressive strength of 40 MPa, were prepared. They were respectively designated mixtures E and F. In mixture E, 100% ordinary Portland cement (OPC) was used as binder. The composition of mixture F was based on a conclusion made on the basis of the results of Example 3, namely, that up to 20% of OPC can be replaced by partially neutralised red mud to produce a 40 MPa concrete of which the compressive strength is not reduced to below a minimum acceptable level.

Both concretes were mixed to give a slump of 75 mm. It was found necessary to increase the water to binder ratio for the concrete containing the 20% partially neutralized red mud. The compositions of the two mixtures were as given in Table 7, in which the masses of solids are reflected as Saturated Surface Dry weights per cubic meter.

TABLE 7

| | MIXTURE E | MIXTURE F |
|---|---|---|
| Ordinary Portland Cement (OPC) (kg) | 325 | 255.2 |
| Partially neutralized red mud | 0 | 63.8 |
| Water (l) | 172 | 194 |
| Aggregate (14 mm) (kg) | 578 | 567 |
| Aggregate (9 mm) (kg) | 652 | 639 |
| Sand (kg) | 790 | 774 |
| Water reducing agent (l) | 1.72 | 1.69 |
| Water binder ratio | 0.53 | 0.61 |

Samples of both mixtures were allowed to cure continuously in sealed plastic bags, stored in a fog room at 23° C. Samples were tested for compressive strength after various stages. The results were as follows:

The early age compressive strength development over 3 days, for mixtures E and F, was similar. Between 3 and 7 days' curing, the strength of mixture E increased at a higher rate than that of mixture F. From 7 to 28 days both concretes exhibited similar strength gain, with mixture F having an approx 10% lower strength than mixture E after 28 days fog curing. The reduced 28 day compressive strength of mixture F was attributed to the higher water to binder ratio required for a 75 mm slump as compared to the reference mixture E concrete. This need for a higher water to binder ratio, see Table 7, for an equivalent slump, could possibly be overcome by using a more appropriate water reducing agent.

The differential in water to binder ratio between mixture E and mixture F is believed to be partly responsible for the observed reduced 28 day compressive strength for mixture F concrete. However both concretes reached their 28 day design strength of 40 MPa.

The peak semi-adiabatic temperatures of both mixtures E and F were around 30.5° C. and, in both cases, this occurred after 11.25 hours after commencement of mixing.

The workability of the mixture F was lower than that of mixture E because the partially neutralised red mud acted as a set accelerant. However, the reduction in workability of the mixture was overcome by the addition of a plasticizer. The use of partially neutralised red mud as an OPC replacement provided greater initial strength (7-day curing) and a higher semi-adiabatic temperature, after 7 days curing, of 31.5° C. The aforementioned increase in semi-adiabatic temperature is of importance where a low surface area to volume ratio is present, because it may lead to early age cracking from thermal stress. The increase in semi-adiabatic temperature may have been caused by a greater proportion of tetra-calcium alumino-ferrite (C4AF) that was produced during curing and because less tri-calcium silicate (C3S) and di-calcium silicate (C2S) were formed in the Portland cement used in the concrete. Alternatively, the cement may have been converted into a high alumina type cement, because of the additional aluminates supplied by the partially neutralised red mud.

### Example 10

### Fine Detail Preservation

Three nonporous compositions (4 parts partially neutralised red mud and 1 part cement; mix G), (3 parts partially neutralised red mud, 1 part sand and 1 part cement; mix H), and mortar (4 parts sand and 1 part cement; mix 1), were poured into 250 mL moulds, where fine embossed lettering for volume graduations was present on the inside wall of the mould. When the blocks had cured the moulds were broken away and both mixes G and H had preserved the fine detail such that the graduations were easily read, whereas mix I had not preserved this detail. The preservation of fine detail on the surface of a cementitious composition is important for the production of non-slip tiles and concrete paths. The fine detail able to be taken by the partially neutralised red mud in cementitious compositions suggests that fine detail can be created on the surface of tiles or other fabrications such as concrete sculptures or decorative (e.g. embossed or moulded) facings for buildings and walls. Very fine lines that can use the capillary draw provided by surface tension of water may draw water into these fine channels and remove the water before it becomes a slip hazard.

### Example 11

### Terracotta Tiles

A porous styled cement composition comprising 1 part cement, 1 part sand and 3 parts partially neutralised red mud was produced that had very good wetting and drying resistance. Terracotta cement pavers made from this composition also had a good freeze/thaw resistance. These pavers compared favourably with conventional pavers made by sprinkling an oxide powder on the surface of cement pavers, after they have been formed and whilst the pavers were still wet. In the case of such conventional pavers, wear on the oxide coating after some time reveals the underlying (uncoloured) cement, whereas wear on tiles made according to the processes of this invention has no impact on colour because the tiles have a uniform colour throughout.

### Example 12

### Blown Cement Compositions

By combining the composition of Example 10 with EP2021 (a foaming agent), lightweight (porous) flagging stones and tiles were produced.

### Example 13

### Acid Neutralisation

Three nonporous compositions, mix J, mix K, and mix L, were prepared as in Example 8. One sample from each mix was allowed to cure for several days before drilling a central hole into it and sawing off a 1.5 cm thick slab. The three slabs were then suspended in separate 1 L jars of milli-Q water and the pH was adjusted to 2.5. The pH of each was readjusted every few days back to pH 2.5 with small additions of sulfuric acid until a total of 50 mL of sulfuric acid had been added to each jar. After the incremental addition of 50 mL of the acid to each jar over about 2 months, the samples were allowed to equilibrate with the solution in the jar for 4 weeks to bring the solution pH into equilibrium with the slabs, before they were removed to allow examination of the surfaces. Solution pH during the 4 week equilibration time was monitored twice weekly. Sample J reached equilibrium with the cement slab within the first week, sample K reached equilibrium by the middle of the second week, and sample L reached equilibrium by the middle of the third week. The final equilibrium pH of each of the solutions was as follows:

| | |
|---|---|
| For the sample of mix J: | 7.94; |
| For the sample of mix K: | 7.88; |
| For the sample of mix L: | 7.79. |

The mix J and K cements raised the pH in the acid solutions much faster than the sample of mix L, indicating that the acid neutralising capacity of the sample of each of these mixtures was more readily available. The sample of mix L finished with quite severe surface etching of the slab and surface mineral deposition. Both the samples of the mix J and K cements showed some etching, but not as much as the sample of mix L. Both the samples of the mix J and K cements also showed mineral deposits on their surfaces, with mix J having the greater amount of deposit. The sample of the mix K cement had fine acicular mineral crystals oh its surface.

### Example 14

### Acid Resistance

One sample of each of mixtures E and F (of Example 4) was immersed in 10% acid solutions of each of HCl, HNO₃, and H₂SO₄. After 8 weeks, all the samples were removed and the mass loss of each was measured. After 1 week in each of the acids, the Portland cement control (mixture E) had completely disintegrated, with a 100% loss, whereas the sample of mixture F immersed in the 10% HNO₃ had lost only 10% of its mass, the sample of mixture F immersed in the 10% HCl had lost about 20% of its mass, and the sample of mixture F immersed in the 10% H₂SO₄ had lost about 40% of its mass.

At 10% strength, the molarities of the acids were 1.2 M for HCl, 1.6 M for HNO₃ and 1.8 M for H₂SO₄. The moles of H⁺ available for attack on the composition were the same for the HCl and the HNO₃, but for the H₂SO₄, there were 3.6 M available. It was thought likely that the greater loss of material from the sample immersed in the sulfuric acid was caused by the 3 times greater hydrogen ion availability compared to that for the HNO₃. The greater susceptibility of the mixture containing partially neutralised red mud to attack by HCl may be explained by the lower resistance to chloride of the compositions according to the invention.

Thus, cementitious compositions prepared in accordance with the invention are particularly suitable for use in areas affected by acid sulfate soils or oxidising sulfidic waste rock or tailings at mine sites. Sulfate resistance is normally associated with a reduction in the proportion of tri-calcium aluminate (C3A) component, and for sulfate resistant cement, a C3A content of 4-10% is desired. The sulfate resistance of compositions according to the invention coupled with the ability to shotcrete the slurry, provide a material that can be sprayed onto open cut pit walls to minimise acid leaching and to prevent oxygen diffusion, preventing further sulfide oxidation.

1. A porous particulate material for treating a fluid containing a contaminant, the particulate material comprising a mixture of a cementitious material and a partially neutralized red mud, wherein the partially neutralized red mud has been pre-treated by contacting it with water having a total hardness supplied by calcium, magnesium or a combination thereof, of at least 3.5 millimoles per liter calcium carbonate equivalent.

2. A porous particulate material as claimed in claim 1, wherein the volume of the pores is between 10% and 90% of the volume of the particulate material.

3. A porous particulate material as claimed in claim 1, wherein at least 10% of the pores are open cell or interconnected pores.

4. A porous particulate material as claimed in claim 1, wherein the pores of the particulate material have a distributed pore size.

5. A porous particulate material as claimed in claim 1, wherein the pore size of the particulate material is within the range of 0.1 to 2000 μm.

6. A porous particulate material for treating a fluid containing a contaminant, the particulate material comprising a coherent mass of particles, each of which comprises a mixture of a cementitious material and a partially neutralized red mud, wherein the partially neutralized red mud has been pre-treated by contacting it with water having a total hardness supplied by calcium, magnesium or a combination thereof, of at least 3.5 millimoles per liter calcium carbonate equivalent.

7. A porous particulate material as claimed in claim 6, having a form selected from the group consisting of granules, pellets, briquettes, extrudites, gravel, cobbles, blocks, interlocking blocks and slabs.

8. (canceled)

9. A composition for forming porous particulate material for treating a fluid containing a contaminant, the composition comprising bauxite refinery residue and a cementitious binder, wherein the cementitious binder is present in a sufficient quantity to form a porous particulate material according to claim 1.

10. A composition as claimed in claim 9, the composition further comprising a pore generating agent capable of generating pores within the particulate material upon mixing the composition in an aqueous medium.

11. A composition as claimed in claim 10, wherein the pore generating agent is selected from the group consisting of hydrogen peroxide, organic polymers and a foaming agent.

12. A composition as claimed in claim 9, the composition further comprising a phosphorizing agent.

13. A method for producing porous particulate material for treating a fluid containing a contaminant, the particulate material comprising a coherent mass of particles, the method comprising:
(a) partially neutralizing red mud by contacting it with water having a total hardness supplied by calcium, magnesium or a combination thereof, of at least 3.5 millimoles per liter calcium carbonate equivalent;
(b) mixing the partially neutralized red mud with a cementitious binder in an aqueous medium to form a slurry; and
(c) curing the slurry for a period of time sufficient to form the porous particulate material.

14. A method for producing a porous particulate material for treating a fluid containing a contaminant, the particulate material comprising a coherent mass of particles, the method comprising:
(a) partially neutralizing red mud by contacting it with water having a total hardness supplied by calcium, magnesium or a combination thereof, of at least 3.5 millimoles per liter calcium carbonate equivalent;
(b) mixing the partially neutralized red mud with a cementitious binder in an aqueous medium to form a slurry; and
(c) curing the slurry in a mold to form a coherent mass of the porous particulate material, wherein the mold is shaped to impart to the porous particulate material a form selected from the group consisting of granules, pellets, briquettes, extrudites, gravel, cobbles, blocks, interlocking blocks and slabs.

15. A method for producing porous particulate material for treating a fluid containing a contaminant, the particulate material comprising a coherent mass of particles, the method comprising:
(a) partially neutralizing red mud by contacting it with water having a total hardness supplied by calcium, magnesium or a combination thereof, of at least 3.5 millimoles per liter calcium carbonate equivalent;
(b) mixing the partially neutralized red mud with a cementitious binder in aqueous medium to form a slurry; and
(c) curing the slurry for a period of time sufficient to form the porous particulate material,
wherein a phosphorizing agent is added in step (a) and mixed with the residue and the binder to assist in stabilization of the pore structures during curing.

16. A method as claimed in claim 13, wherein the slurry comprises from about 1% to about 99% w/w of bauxite refinery residue and from about 1% to about 99% w/w of a cementitious binder.

17. A method as claimed in claim 13, wherein the slurry further comprises one or more additives selected from the group consisting of sand, ground caustic steel slag residue, alkali metal hydroxides, alkali metal carbonates, alkaline earth metal hydroxides, alkaline earth metal carbonates, alkaline earth metal oxides, calcium hypochlorite, sodium alum, ferrous sulfate, ferric sulphate, ferric chloride, aluminum sulfate, gypsum, phosphates, phosphoric acid, hydrotalcite, zeolites, olivines, pyroxenes, barium chloride, silicic acid and salts thereof, meta silicic acid and salts thereof, an alunite group mineral, magadiite, a silica provider, a plasticizer, a polymerizer, a phosphatizing agent, and an air entraining agent.

18. A method as claimed in claim 13, wherein the bauxite refinery residue has a pH less than about 10.5.

19. A method as claimed in claim 13, wherein the cementitious binder is capable of forming a tobermorite gel.

20. A method for treating a fluid containing a contaminant, the method comprising;
providing a permeable mass of porous particulate materials according to claim 1, and
passing the fluid containing the contaminant through the permeable mass of porous particulate materials.

21. A cementitious composition comprising partially neutralized red mud and cement, wherein the partially neutralized red mud has been pre-treated by contacting it with water having a total hardness supplied by calcium, magnesium or a combination thereof, of at least 3.5 millimoles per liter calcium carbonate equivalent.

22. A cementitious composition as claimed in claim 21, wherein the cement is present in the composition in a concentration of from about 1 wt % to about 99 wt % and the partially neutralized red mud is present in the composition in a concentration of from about 99 wt % to about 1 wt %.

23. A cementitious composition as claimed in claim 21, further comprising from 0.2 wt % to 3 wt % of the cement of a super plasticizer.

24. A cementitious composition as claimed in claim 21, further comprising a plasticizer selected from the group consisting of cellulose ethers, methyl-hydroxyethyl-cellulose (MHEC) and hydroxypropyl-methyl-cellulose (HPMC).

25. A process for the manufacture of a cementitious composition comprising:
(a) contacting red mud recovered from the Bayer Process with water having a total hardness supplied by calcium, magnesium or a combination thereof, of at least 3.5 millimoles per liter calcium carbonate equivalent, so as to obtain a partially neutralized red mud; and
(b) mixing the partially neutralized red mud with cement so as to obtain the cementitious composition.

26. A process for the manufacture of a cementitious composition as claimed in claim 25, wherein, in step (a), the pH of the red mud is reduced to a value of at most about 10.5 and at least about 8.2.

27. A process for the manufacture of a cementitious composition as claimed in claim 25, including a step (a1), after step (a) and before step (b), in which the partially neutralized red mud is dried to obtain a dry solid material.

28. A process for the manufacture of a cementitious composition as claimed in claim 25, including a step (a1), after step (a) and before step (b), in which the partially neutralized red mud is dried to obtain a dry solid material and a further step (a2), after step (a1) and before step (b), in which the dry solid material of step (a1) is comminuted so as to obtain a partially neutralized dry, comminuted red mud.

29. A composition for forming porous particulate material for treating a fluid containing a contaminant, the composition comprising bauxite refinery residue and a cementitious binder, wherein the cementitious binder is present in a sufficient quantity to form a porous particulate material according to claim 6.

30. A composition as claimed in claim 29, the composition further comprising a pore generating agent capable of generating pores within the particulate material upon mixing the composition in an aqueous medium.

31. A composition as claimed in claim 30, wherein the pore generating agent is selected from the group consisting of hydrogen peroxide, organic polymers and a foaming agent.

32. A composition as claimed in claim 29, the composition further comprising a phosphorizing agent.

33. A method as claimed in claim 14, wherein the slurry comprises from about 1% to about 99% w/w of bauxite refinery residue and from about 1% to about 99% w/w of a cementitious binder.

34. A method as claimed in claim 15, wherein the slurry comprises from about 1% to about 99% w/w of bauxite refinery residue and from about 1% to about 99% w/w of a cementitious binder.

35. A method as claimed in claim 14, wherein the slurry further comprises one or more additives selected from the group consisting of sand, ground caustic steel slag residue, alkali metal hydroxides, alkali metal carbonates, alkaline earth metal hydroxides, alkaline earth metal carbonates, alkaline earth metal oxides, calcium hypochlorite, sodium alum, ferrous sulfate, ferric sulphate, ferric chloride, aluminum sulfate, gypsum, phosphates, phosphoric acid, hydrotalcite, zeolites, olivines, pyroxenes, barium chloride, silicic acid and salts thereof, meta silicic acid and salts thereof, an alunite group mineral, magadiite, a silica provider, a plasticizer, a polymerizer, a phosphatizing agent, and an air entraining agent.

36. A method as claimed in claim 15, wherein the slurry further comprises one or more additives selected from the group consisting of sand, ground caustic steel slag residue, alkali metal hydroxides, alkali metal carbonates, alkaline earth metal hydroxides, alkaline earth metal carbonates, alkaline earth metal oxides, calcium hypochlorite, sodium alum, ferrous sulfate, ferric sulphate, ferric chloride, aluminum sulfate, gypsum, phosphates, phosphoric acid, hydrotalcite, zeolites, olivines, pyroxenes, barium chloride, silicic acid and salts thereof, meta silicic acid and salts thereof, an alunite group mineral, magadiite, a silica provider, a plasticizer, a polymerizer, a phosphatizing agent, and an air entraining agent.

37. A method as claimed in claim 14, wherein the bauxite refinery residue has a pH less than about 10.5.

38. A method as claimed in claim 15, wherein the bauxite refinery residue has a pH less than about 10.5.

39. A method as claimed in claim 14, wherein the cementitious binder is capable of forming a tobermorite gel.

40. A method as claimed in claim 15, wherein the cementitious binder is capable of forming a tobermorite gel.

41. A method for treating a fluid containing a contaminant, the method comprising;
providing a permeable mass of porous particulate materials according to claim 6, and
passing the fluid containing the contaminant through the permeable mass of porous particulate materials.
